(19) United States
(12) Patent Application Publication
(10) Pub. No.: US 2019/0340527 A1
(43) Pub. Date: Nov. 7, 2019

(54) GRAPHICAL USER INTERFACE FEATURES FOR UPDATING A CONVERSATIONAL BOT

(71) Applicant: Microsoft Technology Licensing, LLC, Redmond, WA (US)

(72) Inventors: Lars LIDEN, Seattle, WA (US); Jason WILLIAMS, Seattle, WA (US); Shahin SHAYANDEH, Bellevue, WA (US); Matt MAZZOLA, Seattle, WA (US)

(21) Appl. No.: 15/992,143

(22) Filed: May 29, 2018

Related U.S. Application Data
(60) Provisional application No. 62/668,214, filed on May 7, 2018.

(51) Int. Cl. G06N 5/04; G06F 3/0482; G06F 3/0481; G06F 3/0484; G06F 17/27

(52) U.S. Cl. CPC G06N 5/046; G06F 3/0482; G06F 17/2785; G06F 3/04847; G06F 3/04817

(57) ABSTRACT

Various technologies pertaining to creating and/or updating a chatbot are described herein. Graphical user interfaces (GUIs) are described that facilitate updating a computer-implemented response model of the chatbot based upon interaction between a developer and features of the GUIs, wherein the GUIs depict dialogs between a user and the chatbot.

### RELATED APPLICATION

This application claims priority to U.S. Provisional Patent Application No. 62/668,214, filed on May 7, 2018, and entitled “GRAPHICAL USER INTERFACE FEATURES FOR UPDATING A CONVERSATIONAL BOT”, the entirety of which is incorporated herein by reference.

### BACKGROUND

A chatbot refers to a computer-implemented system that provides a service, where the chatbot is conventionally based upon hard-coded rules, and further wherein people interact with the chatbot by way of a chat interface. The service can be any suitable service, ranging from functional to fun. For example, a chatbot can be configured to provide customer service support for a website that is designed to sell electronics, a chatbot can be configured to provide jokes in response to a request, etc. In operation, a user provides input to the chatbot by way of an interface (where the interface can be a microphone, a graphical user interface that accepts input, etc.), and the chatbot responds to such input with response(s) that are identified (based upon the input) as being helpful to the user. The input provided by the user can be natural language input, selection of a button, entry of data into a form, an image, video, location information, etc. Responses output by the chatbot in response to the input may be in the form of text, graphics, audio, or other types of human-interpretable content.

Conventionally, creating a chatbot and updating a deployed chatbot are arduous tasks. In an example, when a chatbot is created, a computer programmer is tasked with creating the chatbot in code or through user interfaces with tree-like diagramming tools, wherein the computer programmer must understand the area of expertise of the chatbot to ensure that the chatbot properly interacts with users. When users interact with the chatbot in unexpected manners, or when new functionality is desired, the chatbot can be updated; however, to update the chatbot, the computer programmer (or another computer programmer who is a domain expert and who has knowledge of the current operation of the chatbot) must update the code, which can be time-consuming and expensive.

### SUMMARY

The following is a brief summary of subject matter that is described in greater detail herein. This summary is not intended to be limiting as to the scope of the claims.

Described herein are various technologies related to graphical user interface (GUI) features that are well-suited to create and/or update a chatbot. In an exemplary embodiment, the chatbot can comprise computer-executable code, an entity extractor module that is configured to identify and extract entities in input provided by users, and a response model that is configured to select outputs to provide to the users in response to receipt of the inputs from the users (where the outputs of the response model are based upon most recently received inputs, previous inputs in a conversation, and entities identified in the conversation). For instance, the response model can be an artificial neural network (ANN), such as a recurrent neural network (RNN), or other suitable neural network, which is configured to receive input (such as text, location, etc.) and provide an output based upon such input.

The GUI features described herein are configured to facilitate training the extractor module and/or the response model referenced above. For example, the GUI features can be configured to present types of entities and parameters corresponding thereto to a developer; wherein entity types can be customized by the developer; and the parameters can indicate whether an entity type can appear in user input, system responses, or both; whether the entity type supports multiple values; and whether the entity type is negatable. The GUI features are further configured to present a list of available responses, and are further configured to allow a developer to edit an existing response or add a new response. When the developer indicates that a new response is to be added, the response model is modified to support the new response. Likewise, when the developer indicates that an existing response is to be modified, the response model is updated to support the modified response.

The GUI features described herein are also configured to support adding a new training dialog for the chatbot, where a developer can set forth input for purposes of training the entity extractor module and/or the response model. A training dialog refers to a conversation between the chatbot and the developer that is conducted by the developer to train the entity extractor module and/or the response model. When the developer provides input to the chatbot, the GUI features identify entities in user input identified by the extractor module, and further identify the possible responses of the chatbot. In addition, the GUI features illustrate probabilities corresponding to the possible responses, so that the developer can understand how the chatbot chose to respond, and further to indicate to the developer where more training may be desirable. The GUI features are configured to receive input from the developer as to the correct response from the chatbot, and interaction between the chatbot and the developer can continue until the training dialog has been completed.

In addition, the GUI features are configured to allow the developer to select a previous interaction between a user and the chatbot from a log, and to train the chatbot based upon the previous interaction. For instance, the developer can be presented with a dialog (e.g., conversation) between an end user (e.g., other than the developer) and the chatbot, where the dialog includes input set forth by the user and further includes corresponding responses of the chatbot. The developer can select an incorrect response from the chatbot and can inform the chatbot of a different, correct, response. The entity extractor module and/or the response model are then updated based upon the correct response identified by the developer. Hence, the GUI features described herein are configured to allow the chatbot to be interactively trained by the developer.

With more specificity regarding interactive training of the response model, when the developer sets forth input as to a correct response, the response model is re-trained, thereby allowing for incremental retraining of the response model. Further, an in-progress dialog can be re-attached to a newly retrained response model. As mentioned previously, output of the response model is based upon most recently received input, previously received inputs, previous responses to previously received inputs, and recognized entities. Therefore, a correction made to a response output by the response model may impact future responses of the response model in the dialog; hence, the dialog can be re-attached to the retrained response model, such that outputs from the response model as the dialog continues are from the retrained response model.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an exemplary system that facilitates presentment of GUI features on a display of a client computing device operated by a developer, wherein the GUI features are configured to allow the developer to interactively update a chatbot.

FIGS. 2-23 depict exemplary GUIs that are configured to assist a developer with updating a chatbot.

FIG. 24 is a flow diagram illustrating an exemplary methodology for creating and/or updating a chatbot.

FIG. 25 is a flow diagram illustrating an exemplary methodology for creating and/or updating a chatbot.

FIG. 26 is a flow diagram illustrating an exemplary methodology for updating an entity extraction label within a conversation flow.

FIG. 27 is an exemplary computing system.

### DETAILED DESCRIPTION

Various technologies pertaining to GUI features that are well-suited for creating and/or updating a chatbot are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component”, “module”, and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Additionally, as used herein, the term “exemplary” is intended to mean serving as an illustration or example of something, and is not intended to indicate a preference.

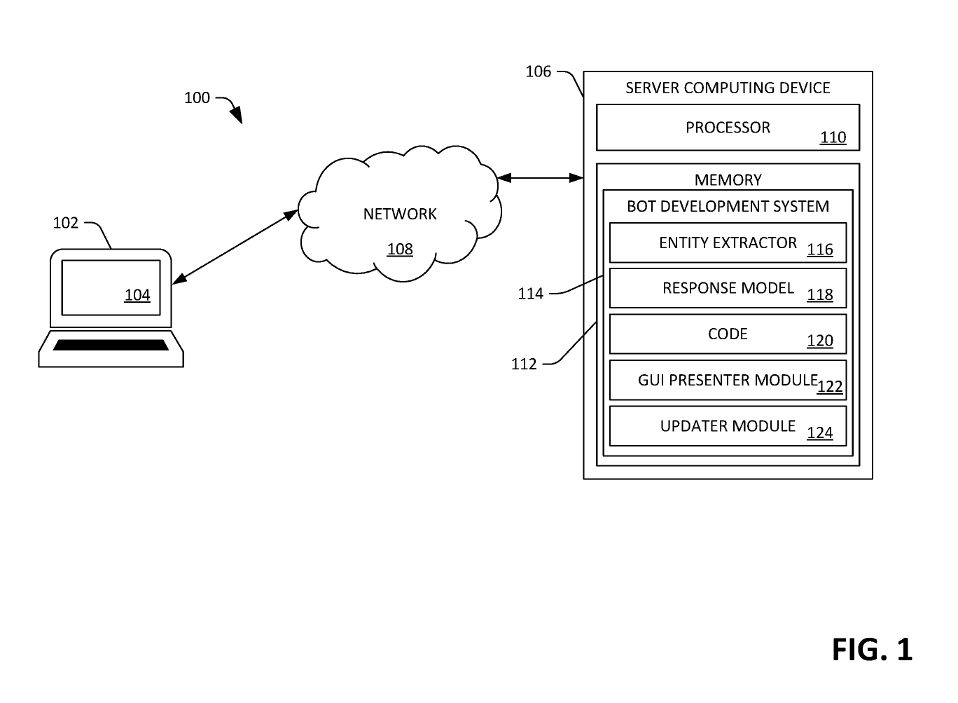

With reference to FIG. 1, an exemplary system 100 for interactively creating and/or modifying a chatbot is illustrated. A chatbot is a computer-implemented system that is configured to provide a service. The chatbot can be configured to receive input from the user, such as transcribed voice input, textual input provided by way of a chat interface, location information, an indication that a button has been selected, etc. Thus, the chatbot can, for example, execute on a server computing device and provide responses to inputs set forth by way of a chat interface on a web page that is being viewed on a client computing device. In another example, the chatbot can execute on a server computing device as a portion of a computer-implemented personal assistant.

The system 100 comprises a client computing device 102 that is operated by a developer who is to create a new chatbot and/or update an existing chatbot. The client computing device 102 can be a desktop computing device, a laptop computing device, a tablet computing device, a mobile telephone, a wearable computing device (e.g., a head-mounted computing device), or the like. The client computing device 102 comprises a display 104, whereupon graphical features described herein are to be shown on the display 104 of the client computing device 102.

The system 100 further includes a server computing device 106 that is in communication with the client computing device 102 by way of a network 108 (e.g., the Internet or an intranet). The server computing device 106 comprises a processor 110 and memory 112, wherein the memory 112 has a chatbot development system 114 (bot development system) loaded therein, and further wherein the bot development system 114 is executable by the processor 110. While the exemplary system 100 illustrates the bot development system 114 as executing on the server computing device 106, it is to be understood that all or portions of the bot development system 114 may alternatively execute on the client computing device 102.

The bot development system 114 includes or has access to an entity extractor module 116, wherein the entity extractor module 116 is configured to identify entities in input text provided to the entity extractor module 116, wherein the entities are of a predefined type or types. For instance, and in accordance with the examples set forth below, when the chatbot is configured to assist with placing an order for a pizza, a user may set forth the input “I would like to order a pizza with pepperoni and mushrooms.” The entity extractor module 116 can identify “pepperoni” and “mushrooms” as entities that are to be extracted from the input.

The bot development system 114 further includes or has access to a response model 118 that is configured to provide output, wherein the output is a function of the input received from the user, and further wherein the output is optionally a function of entities identified by the extractor module 116, previous output of the response model 118, and/or previous inputs to the response model. For instance, the response model 118 can be or include an ANN, such as an RNN, wherein the ANN comprises an input layer, one or more hidden layers, and an output layer, wherein the output layer comprises nodes that represent potential outputs of the response model 118. The input layer can be configured to receive input from a user as well as state information (e.g., where in the ordering process the user is in when the user sets forth the input). In a non-limiting example, the output nodes can represent the potential outputs “yes”, “you're welcome”, “would you like any other toppings”, “you have $toppings on your pizza”, “would you like to order another pizza”, “I can't help with that, but I can help with ordering a pizza”, amongst others (where “$toppings” is used for entity substitution, such that a call to a location in memory 112 is made such that identified entities replace $toppings in the output). Continuing the example set forth above, after the entity extractor module 116 identifies “pepperoni” and “mushrooms” as being entities, the response model 118 can output data that indicates that the most likely correct response is “you have $toppings on your pizza”, where “$toppings” (in the output of the response model 118) is substituted with the entities “pepperoni” and “mushrooms.”. Therefore, in this example, the response model 118 provides the user with the response “you have pepperoni and mushrooms on your pizza.”

The bot development system 114 additionally comprises computer-executable code 120 that interfaces with the entity extractor module 116 and the response model 118. The computer-executable code 120, for instance, maintains a list of entities set forth by the user, adds entities to the list when requested, removes entities from the list when requested, etc. Additionally, the computer-executable code 120 can receive output of the response model 118 and return entities from the memory 112, when appropriate. Hence, when the response model 118 outputs “you have $toppings on your pizza”, “$toppings” can be a call to the code 120, which retrieves “pepperoni” and “mushrooms” from the list of entities in the memory 112, resulting in “you have pepperoni and mushrooms on your pizza” being provided as the output of the chatbot.

The bot development system 114 additionally includes a graphical user interface (GUI) presenter module 122 that is configured to cause a GUI to be shown on the display 104 of the client computing device 102, wherein the GUI is configured to facilitate interactive updating of the entity extractor module 116 and/or the response model 118. Various exemplary GUIs are presented herein, wherein the GUIs are caused to be shown on the display 104 of the client computing device 102 by the GUI presenter module 122, and further wherein such GUIs are configured to assist the developer operating the client computing device 102 with updating the entity extractor module 116 and/or the response model 118.

The bot development system 114 also includes an updater module 124 that is configured to update the entity extractor module 116 and/or the response model 118 based upon input received from the developer when interacting with one or more GUI(s) presented on the display 104 of the client computing device 102. The updater module 124 can make a variety of updates, including but not limited to: 1) training the entity extractor module 116 based upon exemplary input that includes entities; 2) updating the entity extractor module 116 to identify a new entity; 3) updating the entity extractor module 116 with a new type of entity; 4) updating the entity extractor module 116 to discontinue identifying a certain entity or type of entity; 5) updating the response model 118 based upon a dialog set forth by the developer; 6) updating the response model 118 to include a new output for the response model 118; 7) updating the response model 118 to remove an existing output from the response model 118; 8) updating the response model 118 based upon a dialog with the chatbot by a user; amongst others. In an example, when the response model 118 is an ANN, the updater module 124 can update weights assigned to synapses of the ANN, can activate a new input or output node in the ANN, can deprecate an input or output node in the ANN, and so forth.

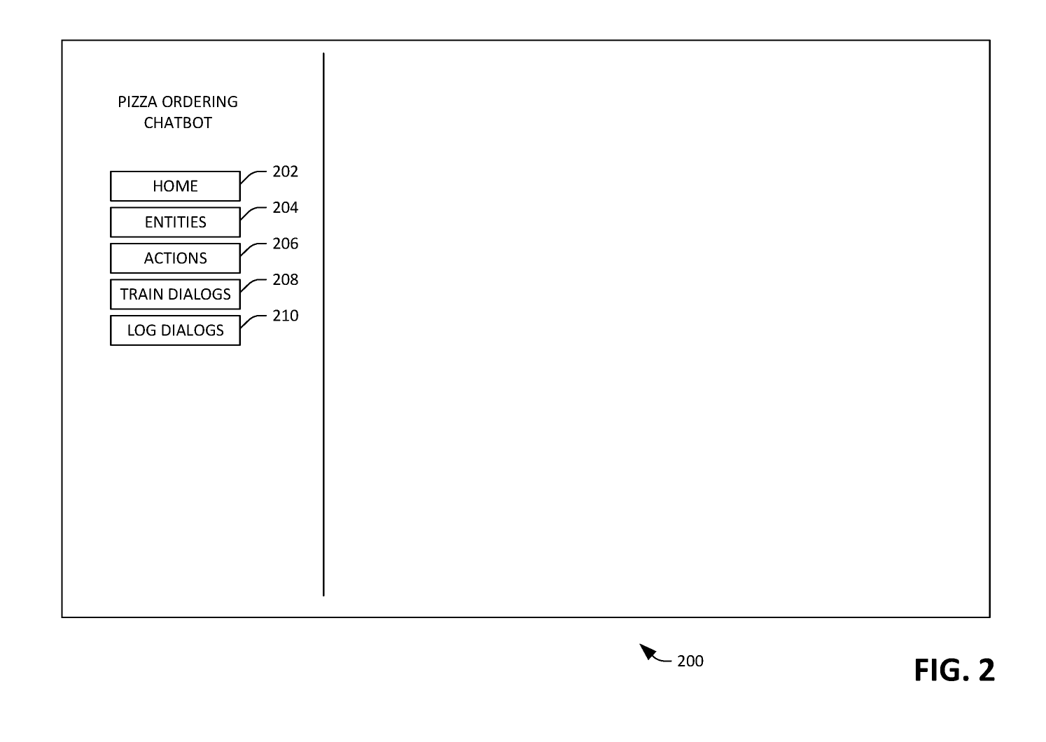

Referring now to FIGS. 2-23, various exemplary GUIs that can be caused to be shown on the display 104 of the client computing device 102 by the GUI presenter module 122 are illustrated. These GUIs illustrate updating an existing chatbot that is configured to assist users with ordering pizza; it is to be understood, however, that the GUIs are exemplary in nature, and the features described herein are applicable to any suitable chatbot that relies upon a machine learning model to generate output. Further, the GUIs are well-suited for use in creating and/or training an entirely new chatbot.

Referring solely to FIG. 2, an exemplary GUI 200 is illustrated, wherein the GUI 200 is presented on the display 104 of the client computing device 102 responsive to the client computing device 102 receiving an indication from the developer that a selected chatbot is to be updated. In the exemplary GUI 200, it is indicated that the selected chatbot is configured to assist an end user with ordering a pizza. The GUI 200 includes several buttons: a home button 202, an entities button 204, an actions button 206, a train dialogs button 208, and a log dialogs button 210. Responsive to the home button 202 being selected, the GUI 200 is updated to present a list of selectable chatbots. Responsive to the entities button 204 being selected, the GUI 200 is updated to present information about entities that are recognized by the currently selected chatbot. Responsive to the actions button 206 being selected, the GUI 200 is updated to present a list of actions (e.g., responses) of the chatbot. Responsive to the train dialogs button 208 being selected, the GUI 200 is updated to present a list of training dialogs (e.g., dialogs between the developer and the chatbot used in connection with training of the chatbot). Finally, responsive to the log dialogs button 210 being selected, the GUI 200 is updated to present a list of log dialogs (e.g., dialogs between the chatbot and end users of the chatbot).

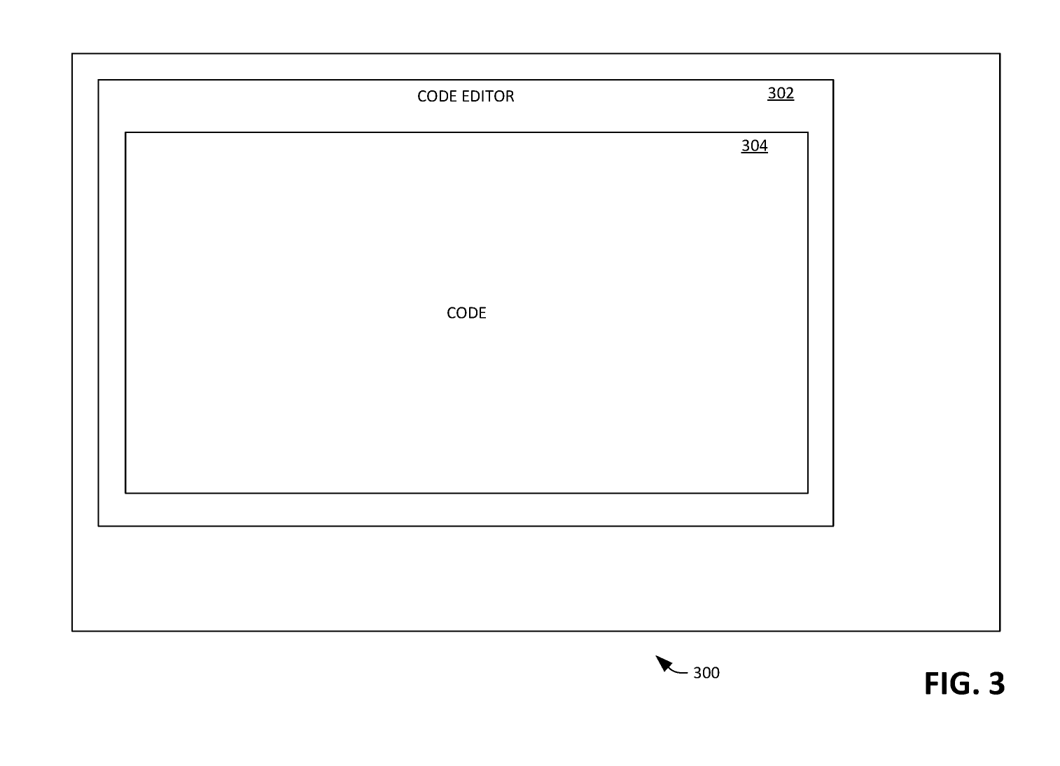

With reference now to FIG. 3, an exemplary GUI 300 is illustrated, wherein the GUI presenter module 122 causes the GUI 300 to be presented on the display 104 of the client computing device 102 responsive to the developer indicating that the developer wishes to view and/or modify the code 120. The GUI 300 can be presented in response to the developer selecting a button on the GUI 200 (not shown). The GUI 300 includes a code editor interface 302, which comprises a field 304 for depicting the code 120. The field 304 can be configured to receive input from the developer, such that the code 120 is updated by way of interaction with code in the field 304.

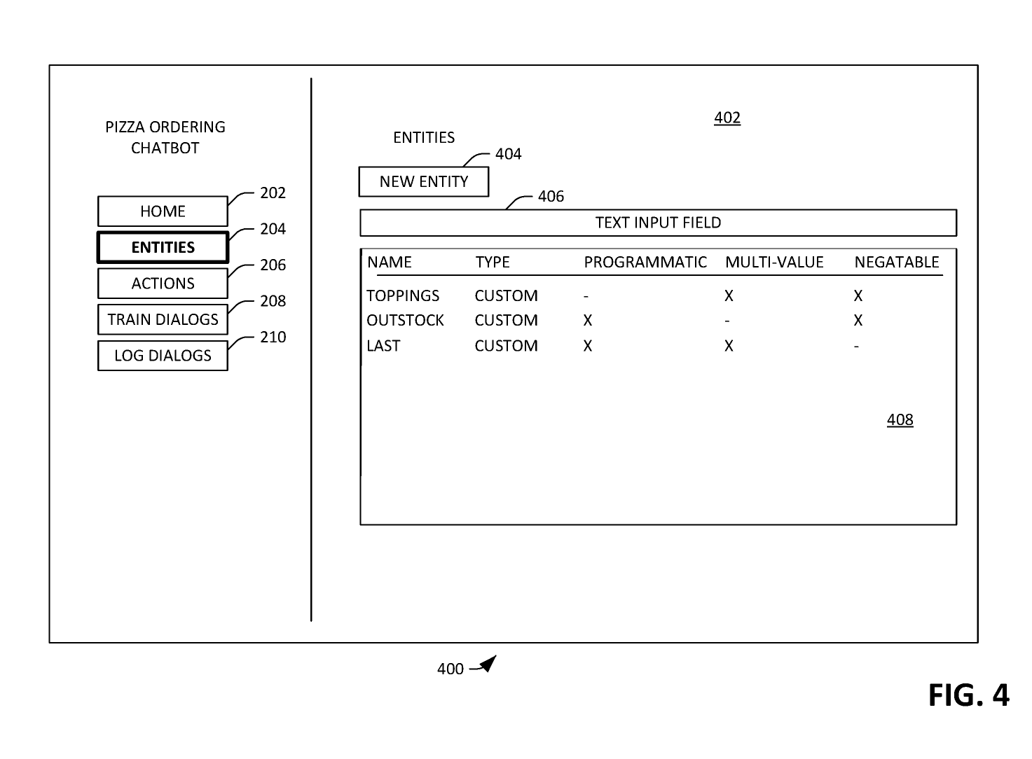

Now referring to FIG. 4, an exemplary GUI 400 is illustrated, wherein the GUI presenter module 122 causes the GUI 400 to be presented on the display 104 of the client computing device 102 responsive to the client computing device 102 receiving an indication that the developer has selected the entities button 204. The GUI 400 comprises a field 402 that includes a new entity button 404, wherein creation of a new entity that is to be considered by the chatbot is initiated responsive to the new entity button 404 being selected. The field 402 further includes a text input field 406, wherein a query for entities can be included in the text input field 406, and further wherein (existing) entities are searched over based upon such query. The text input field 406 is particularly useful when there are numerous entities that can be extracted by the entity extractor module 116 (and thus considered by the chatbot), thereby allowing the developer to relatively quickly identify an entity of interest.

The GUI 400 further comprises a field 408 that includes identities of entities that can be extracted from user input by the entity extractor module 116, and the field 408 further includes parameters of such entities. Each of the entities in the field 408 is selectable, wherein selection of an entity results in a window being presented that is configured to allow for editing of the entity. In the example shown in FIG. 4, there are three entities (each of a “custom” type) considered by the chatbot: “toppings”, “outstock”, and “last”. “Toppings” can be multi-valued (e.g., “pepperoni and mushrooms”), as can “last” (which represents the last pizza order made by a user). Further, the entities “outstock” and “last” are identified as being programmatic, in that values for such entities are only included in responses of the response model 118 (and not in user input), and further wherein portions of the output are populated by the code 120. For example, sausage may be out of stock at the pizza restaurant, as ascertained by the code 120 when the code 120 queries an inventory system. Finally, the “toppings” and “outstock” entities are identified in the field 408 as being negatable; thus, items can be removed from a list. For instance, “toppings” being negatable indicates that when a $toppings list includes “mushrooms”, input “substitute peppers for mushrooms” would result in the item “mushrooms” being removed from the $toppings list (and the item “peppers” being added to the $toppings list). The parameters “programmatic”, “multi-value”, and “negatable” are exemplary in nature, as other parameters may be desirable.

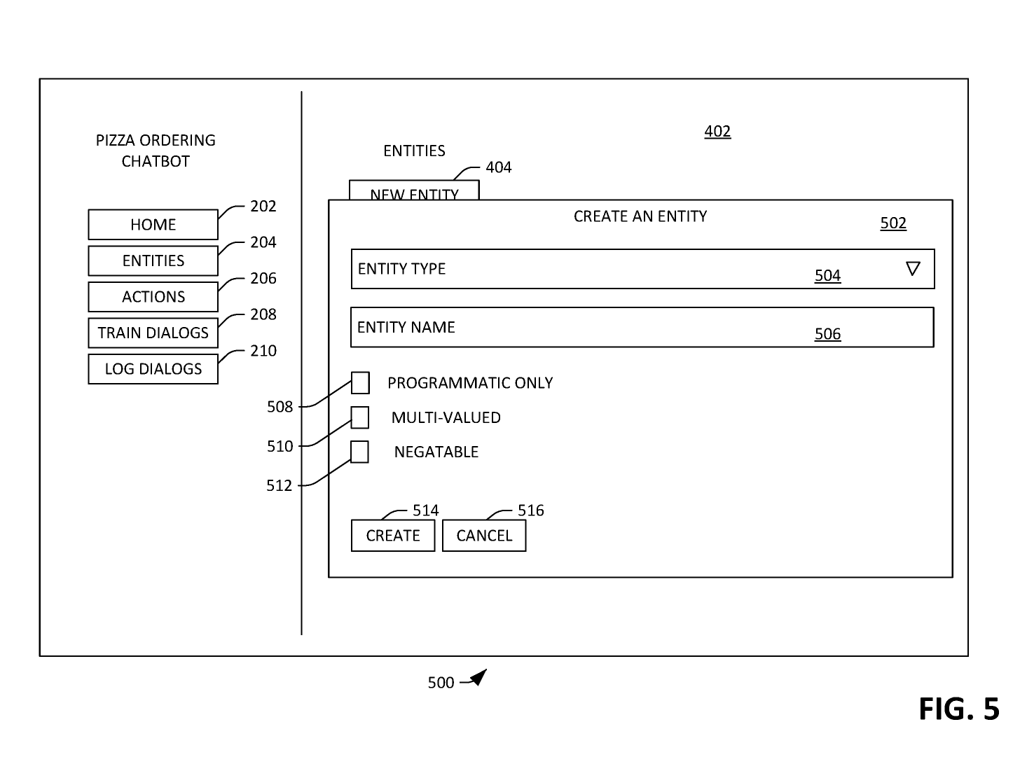

With reference now to FIG. 5, an exemplary GUI 500 is depicted, wherein the GUI presenter module 122 causes the GUI 500 to be presented in response to the developer selecting the new entity button 404 in the GUI 400. The GUI 500 includes a window 502 that is presented over the GUI 400, wherein the window 502 includes a pull-down menu 504. The pull-down menu 504, when selected by the developer, depicts a list of predefined entity types, such that the developer can select the type for the entity that is to be newly created. In other examples, rather than a pull-down menu, the window 502 can include a list of selectable predefined entity types, radio buttons that can be selected to identify an entity type, etc. The window 502 further includes a text entry field 506, wherein the developer can set forth a name for the newly created entity in the text entry field 506. For example, the developer can assign the name “crust-type” to the entity, and can subsequently set forth feedback that causes the entity extractor module 116 to identify text such as “thin crust”, “pan”, etc. as being “crust-type” entities.

The window 502 further comprises selectable buttons 508, 510, and 512, wherein the buttons are configured to receive developer input as to whether the new entity is to be programmatic only, multi-valued, and/or negatable, respectively. The window 502 also includes a create button 514 and a cancel button 516, wherein the new entity is created in response to the create button 514 being selected by the developer, and no new entity is created in response to the cancel button 516 being selected.

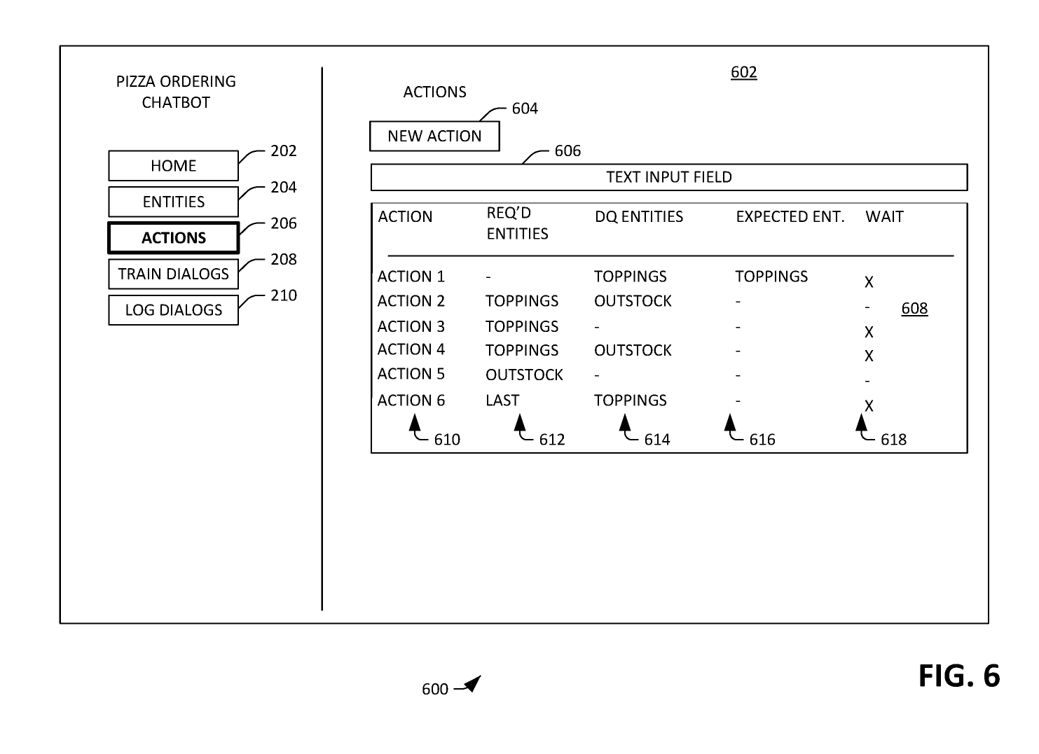

Now referring to FIG. 6, an exemplary GUI 600 is illustrated, wherein the GUI presenter module 122 causes the GUI 600 to be presented on the display 104 of the client computing device 102 responsive to the client computing device 102 receiving an indication that the developer has selected the actions button 206. The GUI 600 comprises a field 602 that includes a new action button 604, wherein creation of a new action (e.g., a new response) of the chatbot is initiated responsive to the new action button 604 being selected. The field 602 further includes a text input field 606, wherein a query for actions can be included in the text input field 606, and further wherein (existing) actions are searched over based upon such query. The text input field 606 is particularly useful when there are numerous actions of the chatbot, thereby allowing the developer to relatively quickly identify an action of interest.

The GUI 600 further comprises a field 608 that includes identities of actions currently performable by the chatbot, and further includes parameters of such actions. Each of the actions represented in the field 608 is selectable, wherein selection of an action results in a window being presented that is configured to allow for editing of the selected action. The field 608 includes columns 610, 612, 614, 616, and 618. In the example shown in FIG. 6, there are 6 actions that are performable by the chatbot, wherein the actions can include responses, application programming interface (API) calls, rendering of a fillable card, etc. As indicated previously, each action can correspond to an output node of the response model 118. The column 610 includes identifiers for the actions, wherein the identifiers can include text of responses, a name of an API call, an identifier for a card (which can be previewed upon an icon being selected), etc. For instance, the first action may be a first response, and the identifier for the first action can include the text “What would you like on your pizza”; the second action may be a second response, and the identifier for the second action can include the text “You have $Toppings on your pizza”; the third action may be a third response, and the identifier for the third action may be “Would you like anything else?”; the fourth action may be an API call, and the identifier for the fourth action can include the API descriptor “FinalizeOrder”; the fifth action may be a fourth response, and the identifier for the fifth action may be “We don't have $OutStock”; and the sixth action may be a fifth response, and the identifier for the sixth action may be “Would you like $LastToppings?”

The column 612 includes identifies of entities that are required for each action to be available, while the column 614 includes identifies of entities that must not be present for each action to be available. For instance, the second action requires that the “Toppings” entity is present, and that the “OutStock” entity is not present. If these conditions are not met, then this action is disqualified. In other words, the response “You have $toppings on your pizza” is inappropriate if a user has not yet provided any toppings, and if there is a topping which has been identified as out of stock.

The column 616 includes identities of entities expected to be received by the chatbot from a user after the action has been set forth to the user. Referring again to the first action, it is expected that a user reply to the first action (the first response) includes identities of toppings that the user wants on his or her pizza. Finally, column 618 identifies values of the “wait” parameter for the actions, wherein the “wait” parameter indicates whether the chatbot should take a subsequent action without waiting for user input. For example, the first action has the wait parameter assigned thereto, which indicates that after the first action (the first response) is issued to the user, the chatbot is to wait for user input prior to performing another action. In contrast, the second action does not have the wait parameter assigned thereto, and thus the chatbot should perform another action (e.g., output another response) immediately subsequent to issuing the second response (and without waiting for a user reply to the second response). It is to be understood that the parameters identified in the columns 610, 612, 614, 616, and 618 are exemplary, as actions may have other parameters associated therewith.

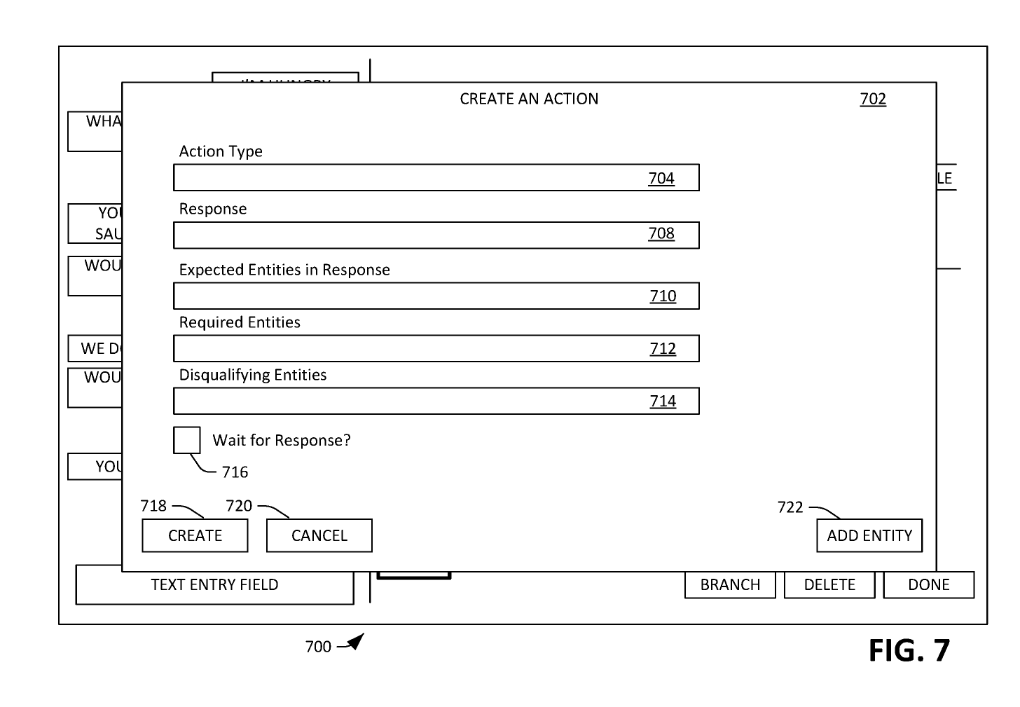

With reference to FIG. 7, an exemplary GUI 700 is illustrated, wherein the GUI presenter module 122 causes the GUI 700 to be presented on the display 104 of the client computing device 102 responsive to receiving an indication that the new action button 504 has been selected. The GUI 700 includes a window 702, wherein the window 702 includes a field 704 where the developer can specify a type of the new action. Exemplary types include, but are not limited to, “text”, “audio”, “video”, “card”, and “API call”, wherein a “text” type of action is a textual response, an “audio” type of action is an audio response, a “video” type of action is a video response, a “card” type of action is a response that includes an interactive card, and an “API call” type of action is a function in code that the developer defines, where the API call can execute arbitrary code, and return text, a card, image, video, etc.—or nothing at all. Thus, while the actions described herein have been illustrated as being textual in nature, other types of chatbot actions are also contemplated. Further, the field 804 may be a text entry field, a pull-down menu, or the like.

The window 702 also includes a text entry field 708, wherein the developer can set forth text into the text entry field 708 that defines the response. In another example, the text entry field 708 can have a button corresponding thereto that allows the developer to navigate to a file, wherein the file is to be a portion of the response (e.g., a video file, an image, etc.). The window 702 additionally includes a field 710 that can be populated by the developer with an identity of an entity that is expected to be present in dialog turns set forth by users in reply to the response. For example, if the response were “What toppings would you like on your pizza?”, an entity expected in the dialog turn reply would be “toppings”. The window 702 additionally includes a required entities field 712, wherein the developer can set forth input that specifies what entities must be in memory for the response to be appropriate. Moreover, the window 702 includes a disqualifying entities field 714, wherein the developer can set forth input to such field 704 that identifies when the response would be inappropriate based upon entities in memory. Continuing with the example set forth above, if the entities “cheese” and “pepperoni” were in memory, the response “What toppings would you like on your pizza?” would be inappropriate, and thus the entity “toppings” may be placed by the developer in the disqualifying entities field 714. A selectable checkbox 716 can be interacted with by the developer to identify whether user input is to be received after the response has been submitted, or whether another action may immediately follow the response. In the example set forth above, the developer would choose to select the checkbox 716, as a dialog turn from the user would be expected.

The window 702 further includes a create button 718, a cancel button 720, and an add entity button 722. The create button 718 is selected when the new action is completed, and the cancel button 720 is selected when creation of the new action is to be cancelled. The new entity button 722 is selected when the developer chooses to create a new entity upon which the action somehow depends. The updater module 124 updates the response model 118 in response to the create button 718 being selected, such that an output node of the response model 118 is unmasked and assigned the newly-created action.

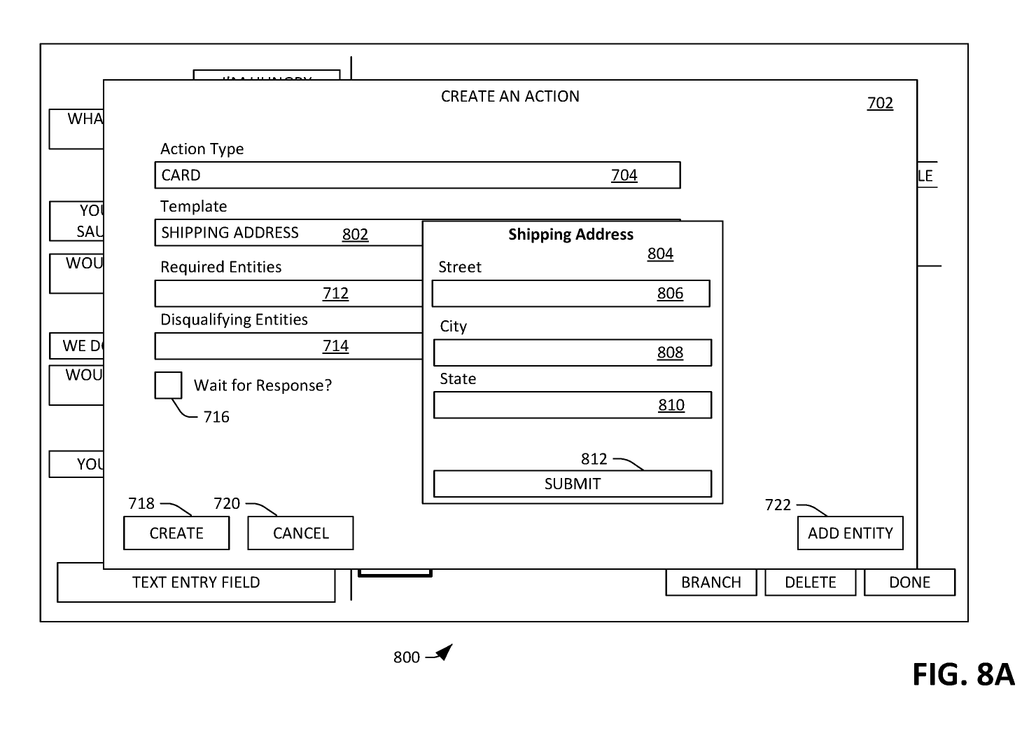

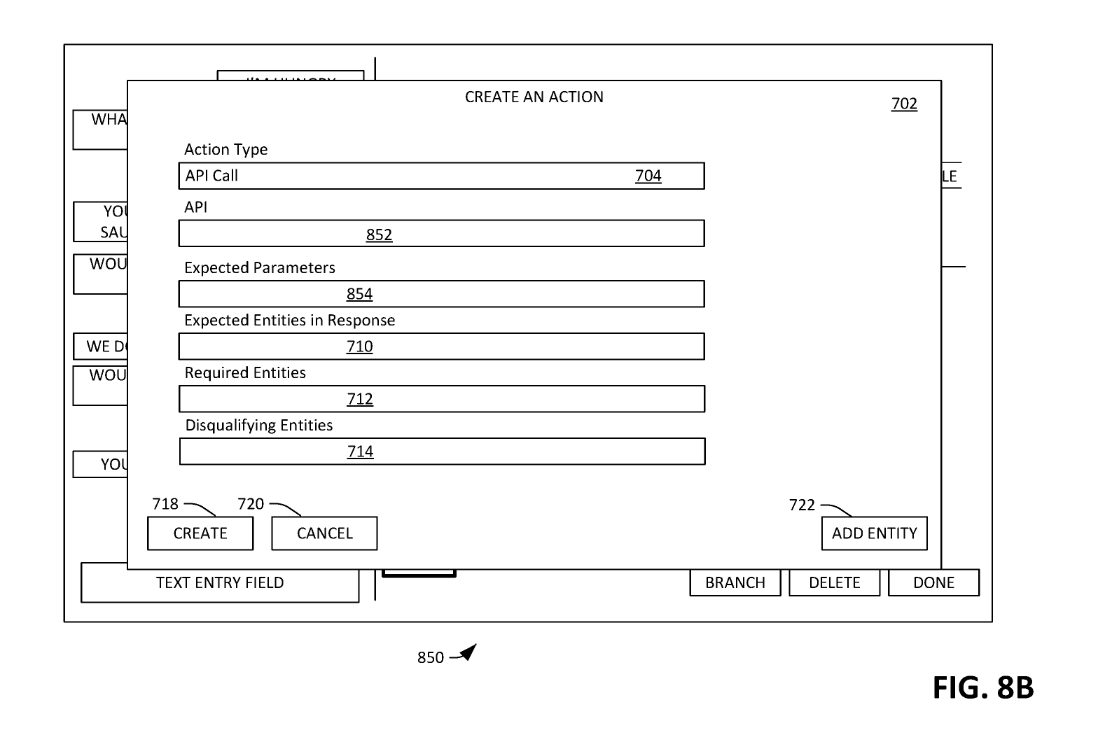

With reference now to FIG. 8A, yet another exemplary GUI 800 is illustrated, wherein the GUI presenter module 122 causes the GUI 800 to be presented responsive to the developer indicating that the developer wishes to create a new action, and further responsive to the developer indicating that the action is to include presentment of a template (e.g., a card) to an end user. The GUI 800 includes the window 702, wherein the window comprises the fields 704, 712, and 714, the checkbox 716, and the buttons 718, 720, and 722. In the field 704, the developer has indicated that the action type is “card”, which results in a template field 802 being included in the window 702. The template field 802, for example, can be or include a pull-down menu that, when selected by the developer, identifies available templates for the card. In the example shown in FIG. 8A, the template selected by the developer is a shipping address template. Responsive to the shipping address template being selected, the GUI presenter module 122 causes a preview 804 of the shipping address template to be shown on the display, wherein the preview 804 comprises a street field 806, a city field 808, a state field 810, and a submit button 812.

Turning to FIG. 8B, yet another exemplary GUI 850 is illustrated, wherein the GUI presenter module 122 causes the GUI 850 to be presented on the display 104 of the client computing device 102 responsive to the client computing device 102 receiving an indication that the developer has selected the new action button 604, and further responsive to the developer indicating that the new action is to be an API call. Specifically, in the exemplary GUI 850, the developer has selected the action type “API Call” in the field 704. Responsive to the action type “API call” being selected, fields 852 and 854 can be presented. The field 852 is configured to receive an identity of an API call. For instance, the field 852 can include a pull-down menu that, when selected, presents a list of available API calls.

The GUI 850 additionally includes a field 854 that is configured to receive parameters that the selected API call is expected to receive. In the pizza ordering example set forth herein, the parameters can include “toppings” entities. In a non-limiting example, the GUI 850 may include multiple fields that are configured to receive parameters, where each of the multiple fields is configured to receive parameters of a specific type (e.g., “toppings”, “crust type”, etc.). While the examples provided above indicate that the parameters are entities, it is to be understood that the parameters can be any suitable parameter, including text, numbers, etc. The GUI 850 further includes fields 710, 712, and 714 with are respectively configured to receive expected entities in a user response to the action, required entities for the action (API call) to be performed, and disqualifying entities for the action.

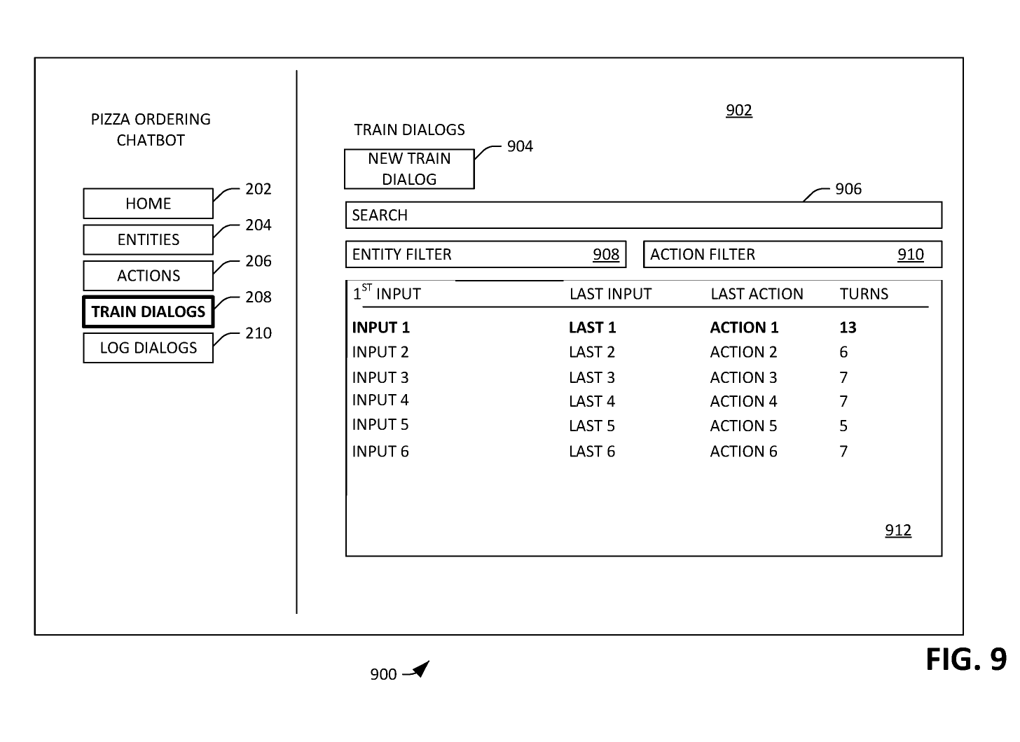

With reference now to FIG. 9, an exemplary GUI 900 is illustrated, wherein the GUI presenter module 122 causes the GUI 900 to be presented on the display 104 of the client computing device 102 responsive to the client computing device 102 receiving an indication that the developer has selected the train dialogs button 208. The GUI 900 comprises a field 902 that includes a new train dialog button 904, wherein creation of a new training dialog between the developer and the chatbot is initiated responsive to the new train dialog button 904 being selected. The field 902 further includes a search field 906, wherein a query for training dialogs can be included in the search field 906, and further wherein (existing) training dialogs are searched over based upon such query. The search field 906 is particularly useful when there are numerous training dialogs already in existence, thereby allowing the developer to relatively quickly identify a training dialog or training dialogs of interest. The field 902 further comprises an entity filter field 908 and an action filter field 910, which allows for existing training dialogs to be filtered based upon entities referenced in the training dialogs and/or actions performed in the training dialogs. Such fields can be text entry fields, pull-down menus, or the like.

The GUI 900 further comprises a field 912 that includes several rows for existing training dialogs, wherein each row corresponds to a respective training dialog, and further wherein each row includes: an identity of a first input from the developer to the chatbot; an identity of a last input from the developer to the chatbot, an identity of the last response of the chatbot to the developer, and a number “turns” in the training dialog (a total number of dialog turns between the developer and the chatbot, wherein a dialog turn is a portion of a dialog). Therefore, “input 1” may be “I'm hungry”, “last 1” may be “no thanks”, and “response 1” may be “your order is finished”. It is to be understood that the information in the rows is set forth to assist the developer in differentiating between various training dialogs and finding desired training dialogs, and that any suitable type of information that can assist a developer in performing such tasks is contemplated. In the example shown in FIG. 9, the developer has selected the first training dialog.

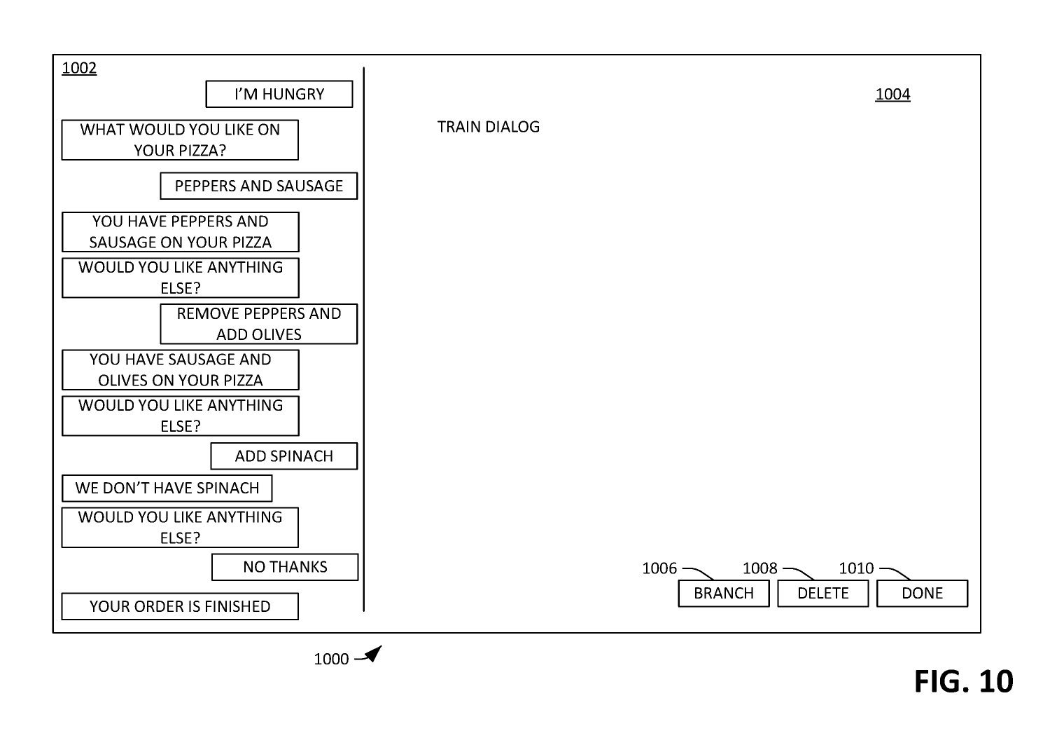

Turning now to FIG. 10, an exemplary GUI 1000 is depicted, wherein the GUI presenter module 122 causes the GUI 1000 to be presented on the display 104 of the client computing device 102 responsive to the client computing device 102 receiving an indication that the developer has selected the first training dialog from the field 912 shown in FIG. 9. The GUI 1000 includes a first field 1002 that comprises a dialog between the developer and the chatbot, wherein instances of dialog set forth by the developer are biased to the right in the field 1002, while instances of dialog set forth by the chatbot are biased to the left in the field 1002. An instance of dialog is an independent portion of the dialog that is presented to the chatbot from the user or presented to the user from the chatbot. Each instance of dialog set forth by the chatbot is selectable, such that the action (e.g., response) performed by the chatbot can be modified for us in retraining the response model 118. In addition, each instance of dialog set forth by the developer is also selectable, such that the input provided to the chatbot can be modified (and the actions of the chatbot observed based upon modification of the instance of dialog). The GUI 1000 further comprises a second field 1004, wherein the second field 1004 includes a branch button 1006, a delete button 1008, and a done button 1010. When the branch button 1006 is selected, the GUI 1000 is updated to allow the developer to fork the current training dialog and create a new one—for example, in a dialog with ten different dialog turns, the developer can select the fifth dialog turn in the dialog (where the user who participated in the dialog said “yes”; the developer can branch on the fifth dialog turn and set forth “no” instead of “yes”, resulting in creation of a new training dialog that has five dialog turns, with the first four dialog turns being the same as the original training dialog but with the fifth dialog turn being “no” instead of “yes”). When the delete button 1008 button is selected (and optionally deletion is confirmed by way of a modal dialog box), the updater module 124 deletes the training dialog, such that future outputs of the entity extractor module 116 and/or the response model 118 are not a function of the training dialog. In addition, the GUI 1000 can be updated in response to a user selecting a dialog turn in the field 1002, wherein the updated GUI can facilitate inserting or deleting dialog turns in the training dialog. When the done button 1010 is selected, the GUI 900 can be presented on the display 104 of the client computing device 102.

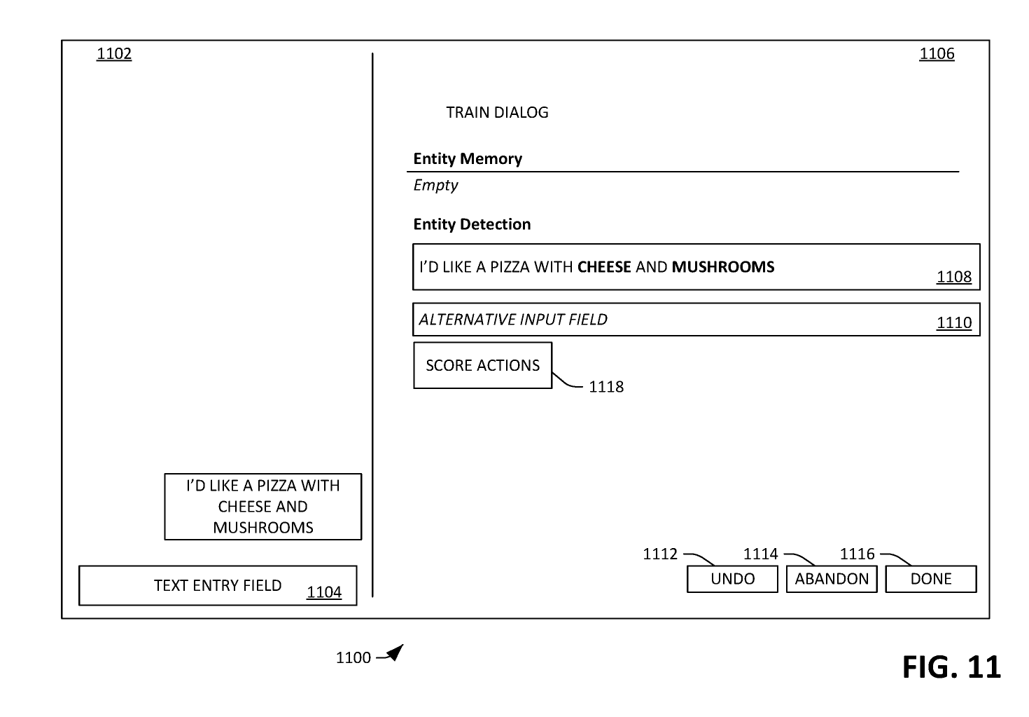

Now referring to FIG. 11, an exemplary GUI 1100 is shown, wherein the GUI 1100 is caused to be presented by the GUI presenter module 122 in response to the developer selecting the new train dialog button 604 in the GUI 600. The GUI 1100 includes a first field 1102 that depicts a chat dialog between the developer and the chatbot. The first field 1102 further includes a text entry field 1104, wherein the developer can set forth text in the text entry field 1104 to provide to the chatbot.

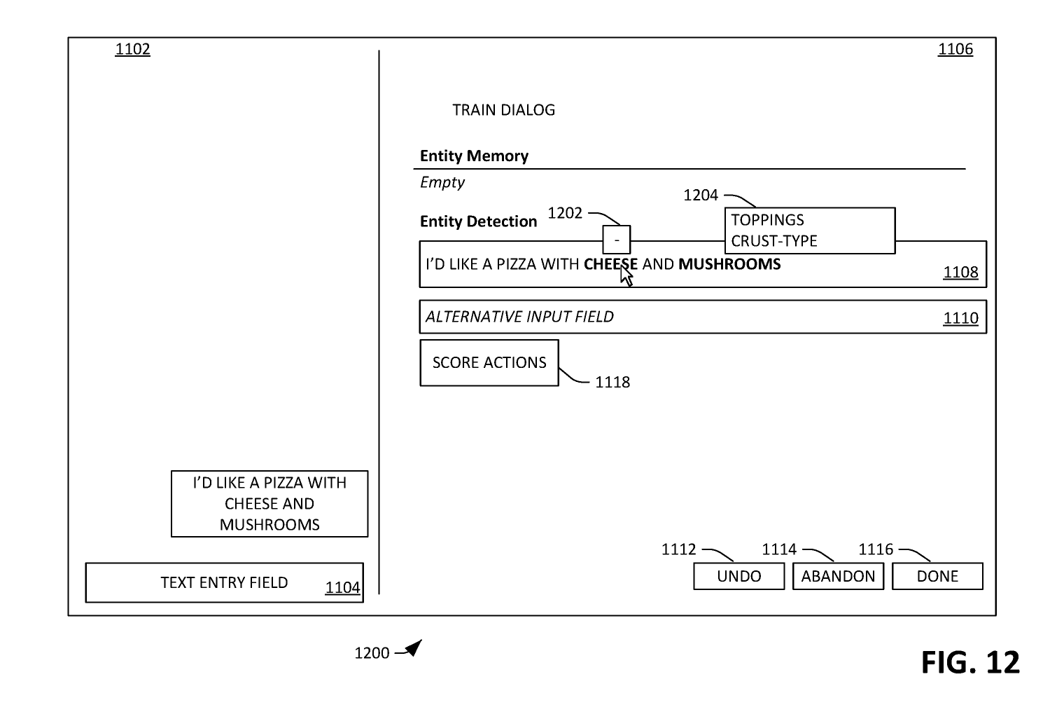

The GUI 1100 also includes a second field 1106, wherein the second field 1106 depicts information about entities identified in the dialog turn set forth by the developer (in this example, the dialog turn “I′d like a pizza with cheese and mushrooms”). The second field 1106 includes a region that depicts identities of entities that are already in memory of the chatbot; in the example shown in FIG. 11, there are no entities currently in memory. The second field 1106 also comprises a field 1108, wherein the most recent dialog entry set forth by the developer is depicted, and further wherein entities (in the dialog turn) identified by the entity extractor module 116 are highlighted. In the example shown in FIG. 11, the entities “cheese” and “mushrooms” are highlighted, which indicates that the entity extractor module 116 has identified “cheese” and “mushrooms” as being “toppings” entities (additional details pertaining to how entity labels are displayed are set forth with respect to FIG. 12, below). These entities are selectable in the GUI 1100, such that the developer can inform the entity extractor module 116 of an incorrect identification of entities and/or a correct identification of entities. Further, other text in the field 1108 is selectable by the developer—for instance, the developer can select the text “pizza” and indicate that the entity extractor module 116 should have identified the text “pizza” as a “toppings” entity (although this would be incorrect). Entity values can span multiple contiguous words, so “italian sausage” could be labeled as a single entity value.

The second field 1106 further includes a field 1110, wherein the developer can set forth alternative input(s) to the field 1110 that are semantic equivalents to the dialog turn shown in the field 1108. For instance, the developer may place “cheese and mushrooms on my pizza” in the field 1110, thereby providing the updater module 124 with additional training examples for the entity extractor module 116 and/or the response model 118.

The second field 1106 additionally includes an undo button 1112, an abandon button 1114, and a done button 1116. When the undo button 1112 is selected, information set forth in the field 1108 is deleted, and a “step backwards” is taken. When the abandon button 1114 is selected, the training dialog is abandoned, and the updater module 124 receives no information pertaining to the training dialog. When the done button 1116 is selected, all information set forth by the developer in the training dialog is provided to the updater module 124, which then updates the entity extractor module 116 and/or the response model 118 based upon the training dialog.

The second field 1106 further comprises a score actions button 1118. When the score actions button 1118 is selected, the entities identified by the entity extractor module 116 can be placed in memory, and the response model 118 can be provided with the dialog turn and the entities. The response model 118 then generates an output based upon the entities and the dialog turn (and optionally previous dialog turns in the training dialog), wherein the output can include probabilities over actions supported by the chatbot (where output nodes of the response model 118 represent the actions).

The GUI 1100 can optionally include an interactive graphical feature that, when selected, causes a GUI similar to that shown in FIG. 3 to be presented, wherein the GUI includes code that is related to the identified entities. For example, the code can be configured to ascertain whether toppings are in stock or out of stock, and can be further configured to move a topping from being in stock to out of stock (or vice versa). Hence, detection of an entity of a certain type in a dialog turn results in a call to code, and a GUI can be presented that includes such code (where the code can be edited by the developer).

Turning now to FIG. 12, an exemplary GUI 1200 is shown, wherein the GUI 1200 is caused to be presented by the GUI presenter module 122 in response to the developer selecting the entity “cheese” in the field 1108 depicted in FIG. 11. In response to selecting such entity, a selectable graphical element 1202 is presented, wherein feedback is provided to the updater module 124 responsive to the graphical element 1202 being selected. In an example, selection of the graphical element 1202 indicates that the entity extractor module 116 should not have identified the selected text as an entity. The updater module 124 receives such feedback and updates the entity extractor module 116 based upon the feedback. In an example, the updater module 124 receives the feedback in response to the developer selecting a button in the GUI 1200, such as the score actions button 1118 or the done button 1116.

FIG. 12 illustrates another exemplary GUI feature, where the developer can define a classification to assign to an entity. More specifically, responsive to the developer selecting the entity “mushrooms” using some selection input (e.g., right-clicking a mouse when the cursor is positioned over “mushrooms”, maintaining contact with the text “mushrooms” using a finger or stylus on a touch-sensitive display, etc.), an interactive graphical element 1204 can be presented. The interactive graphical element 1204 may be a pull-down menu, a popup window that includes selectable items, or the like. For instance, an entity may be a “toppings” entity or a “crust-type” entity, and the interactive graphical element 1204 is configured to receive input from the developer, such that the developer can change or define the entity of the selected text. Moreover, while not shown in FIG. 12, graphics can be associated with an identified entity to indicate to the developer the classification of the entity (e.g., “toppings” vs. “crust-type”). These graphics can include text, assigning a color to text, or the like.

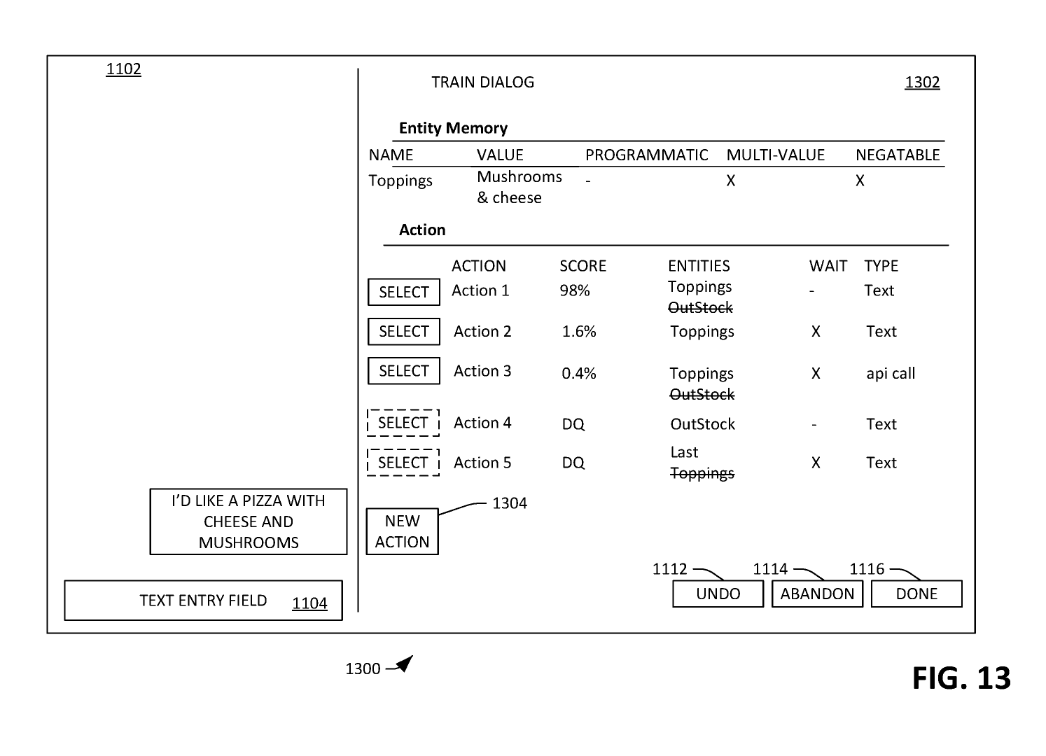

With reference to FIG. 13, an exemplary GUI 1300 is illustrated, wherein the GUI 1300 is caused to be presented by the GUI presenter module 122 in response to the developer selecting the score actions button 1118 in the GUI 1100. The GUI 1300 includes a field 1302 that depicts identities of entities that are in the memory of the chatbot (e.g., cheese and mushrooms as identified by the entity extractor module 116 from the dialog turn shown in the field 1102). The field 1302 further includes identities of actions of the chatbot and scores output by the response model 118 for such actions. In the example shown in FIG. 13, three actions are possible: action 1, action 2, and action 3. Actions 4 and 5 are disqualified, as the entities currently in memory prevent such actions from being taken. In a non-limiting example, action 1 may be the response “You have $Toppings on your pizza”, action 2 may be the response “Would you like anything else?”, action 3 may be the API call “FinalizeOrder”, action 4 may be the response “We don't have $OutStock”, and action 5 may be the response “Would you like $LastTopping?”. It can be ascertained that the response model 118 is configured to be incapable of outputting actions 4 or 5 in this scenario (e.g., these outputs of the response model 118 are masked), as the memory includes “cheese” and “mushrooms” as entities (which are of the entity “toppings”, and not “OutStock”, and therefore precludes output of action 4), and there is no “Last” entity in the memory, which precludes output of action 5.

The response model 118 has identified response 1 as being the most appropriate output. Each possible action (actions 1, 2, and 3) has a select button corresponding thereto; when a select button that corresponds to an action is selected by the developer, the action is selected for the chatbot. The field 1302 also includes a new action button 1304. Selection of the new action button 1304 causes a window to be presented, wherein the window is configured to receive input from the developer, and further wherein the input is used to create a new action. The updater module 124 receives an indication that the new action is created and updates the response model 118 to support the new action. In an example, when the response model 118 is an ANN, the updater module 124 assigns an output node of the ANN to the new action and updates the weights of synapses of the network based upon this feedback from the developer. “Select” buttons corresponding to disqualified actions cannot be selected, as illustrated by the dashed lines in FIG. 13.

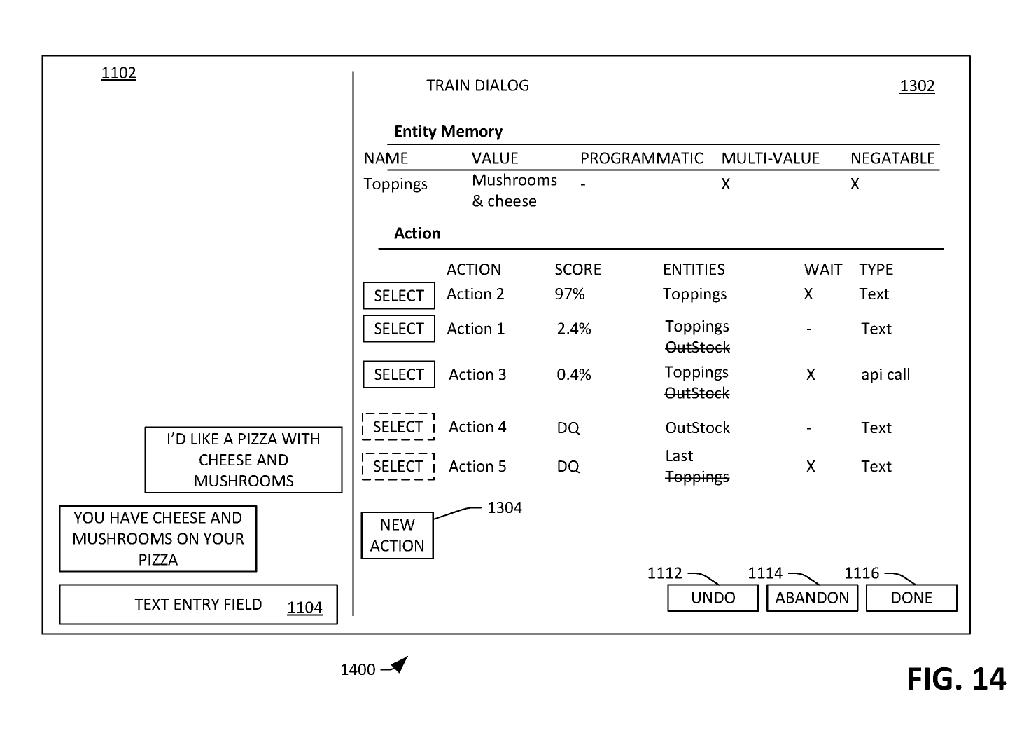

Referring now to FIG. 14, an exemplary GUI 1400 is illustrated, wherein the GUI 1400 is caused to be presented by the GUI presenter module 122 in response to the developer selecting the “select” button corresponding to the first action (the most appropriate action identified by the response model 118) in the GUI 1200. In an exemplary embodiment, the updater module 124 updates the response model 118 immediately responsive to the select button being selected, wherein updating the response model 118 includes updating weights of synapses based upon action 1 being selected as the correct action. The field 1102 is updated to reflect that the first action is performed by the chatbot. As the first action does not require the chatbot to wait for further user input prior to the chatbot performing another action, the field 1302 is further updated to identify actions that the chatbot can next take (and their associated appropriateness). As depicted in the field 1302, the response model 118 has identified the most appropriate action (based upon the state of the dialog and the entities in memory) to be action 2 (the response “Would you like anything else?”), with action 1 and action 3 being the next most appropriate outputs, respectively, and actions 4 and 5 disqualified due to the entities in the memory. As before, the second field 1302 includes “select” buttons corresponding to the actions, wherein “select” buttons corresponding to disqualified actions are unable to be selected.

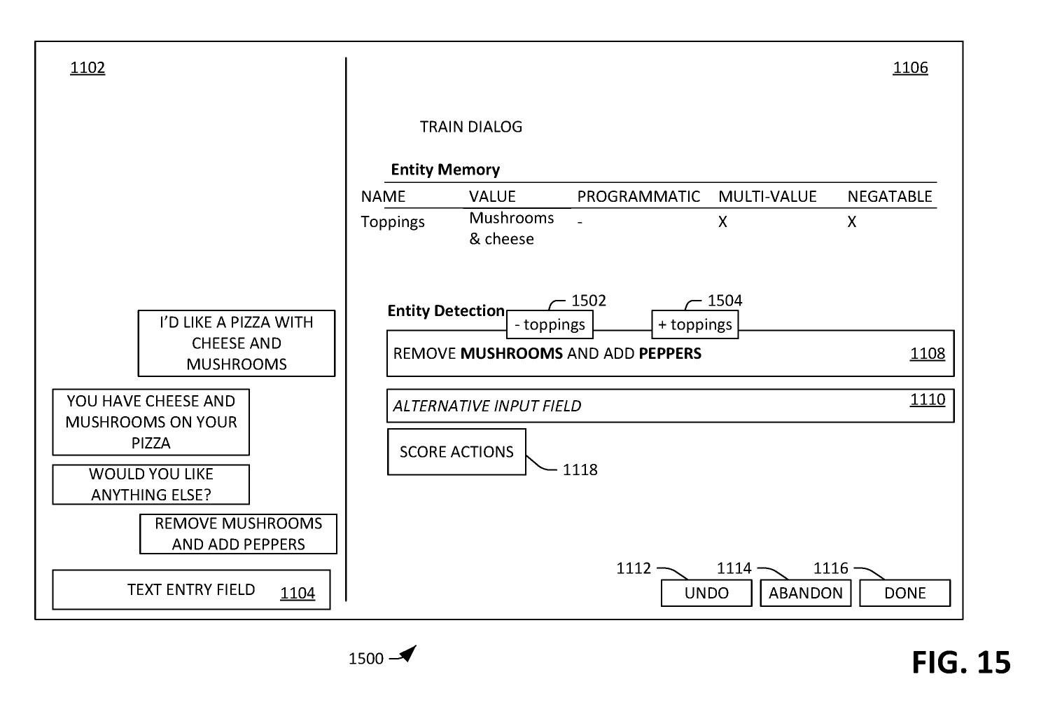

Turning now to FIG. 15, yet another exemplary GUI 1500 is illustrated, wherein the GUI presenter module 122 causes the GUI 1500 to be presented in response to the developer selecting the “select” button corresponding to the second action (the most appropriate action identified by the response model 118) in the GUI 1400, and further responsive to the developer setting forth the dialog turn “remove mushrooms and add peppers” into the text entry field 1104. As indicated in FIG. 11, action 2 indicates that the chatbot is to wait for user input after such response is provided to the user in the field 1102; in this example, the developer has set forth the aforementioned input to the chatbot.

The GUI 1500 includes the field 1106, which indicates that prior to receiving such input, the entity memory includes the “toppings” entities “mushrooms” and “cheese”. The field 1108 includes the text set forth by the developer, with the text “mushrooms” and “peppers” highlighted to indicate that the entity extractor module 116 has identified such text as being entities. Graphical features 1502 and 1504 are graphically associated with the text “mushrooms” and “peppers”, respectively, to indicate that the entity “mushrooms” is to be removed as a “toppings” entity from the memory, while the entity “peppers” is to be added as a “toppings” entity to the memory. The graphical features 1502 and 1504 are selectable, such that the developer can alter what has been identified by the entity extractor module 116. Upon the developer making an alteration in the field 1106, and responsive to the score actions button 1118 being selected, the updater module 124 updates the entity extractor module 116 based upon the developer feedback.

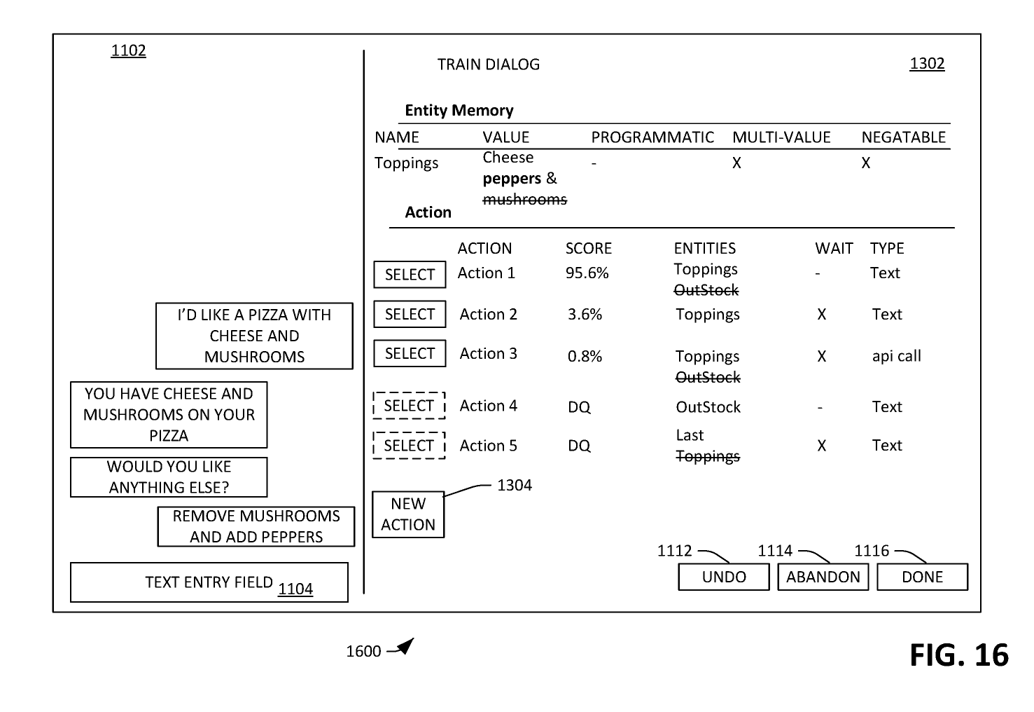

With reference now to FIG. 16, an exemplary GUI 1600 is depicted, wherein the GUI presenter module 122 causes the GUI 1600 to be presented in response to the developer selecting the score actions button 818 in the GUI 1200. Similar to the GUIs 1300 and 1400, the field 1302 identifies actions performable by the chatbot and associated appropriateness for such actions as determined by the response model 118, and further identifies actions that are disqualified due to the entities currently in memory. It is to be noted that the entities have been updated to reflect that “mushrooms” has been removed from the memory (illustrated by strikethrough) while the entities have been updated to reflect that “peppers” have been added to the memory (illustrated by bolding or otherwise highlighting such text). The text “cheese” remains unchanged.

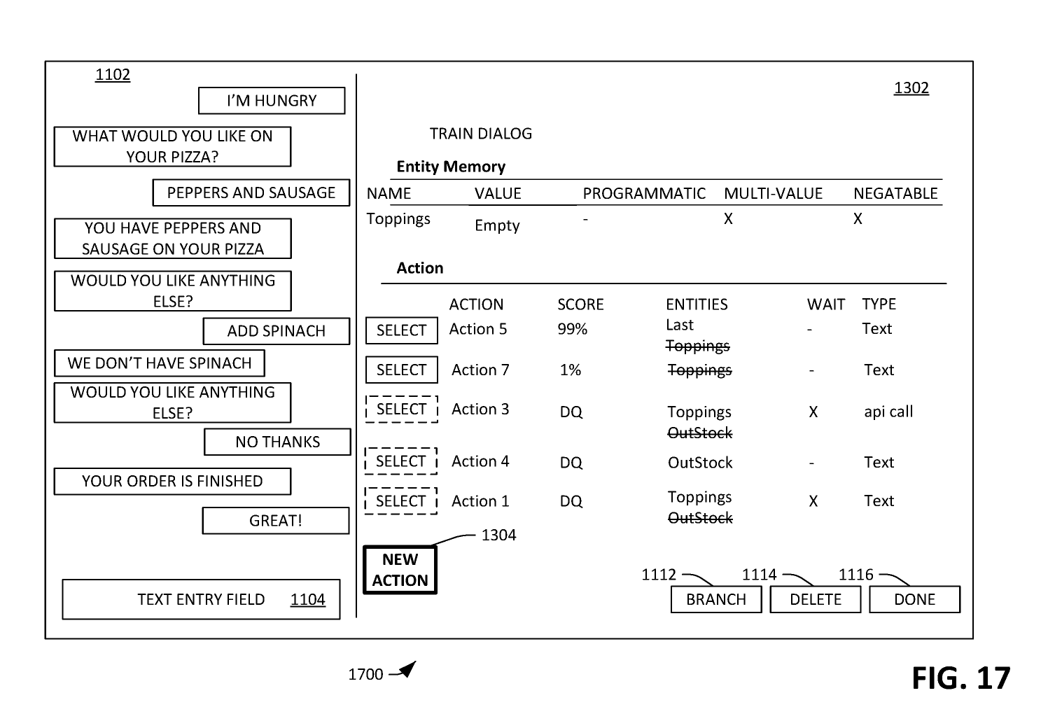

Now referring to FIG. 17, an exemplary GUI 1700 is illustrated. The GUI 1700 depicts a scenario where it may be desirable for the developer to create a new action, as the chatbot may lack an appropriate action for the most recent dialog turn set forth to the chatbot by the developer. Specifically, the developer has set forth the dialog turn “great!” in response to the chatbot indicating that the order has been completed. The response model 118 has indicated that action 5 (the response “Would you like $Lasttopping?”) is the most appropriate action from amongst all actions that can be performed by the response model 118; however, it can be ascertained that this action seems unnatural given the remainder of the dialog. Hence, the GUI presenter module 122 receives an indication that the new action button 1004 has been selected at the client computing device 102.

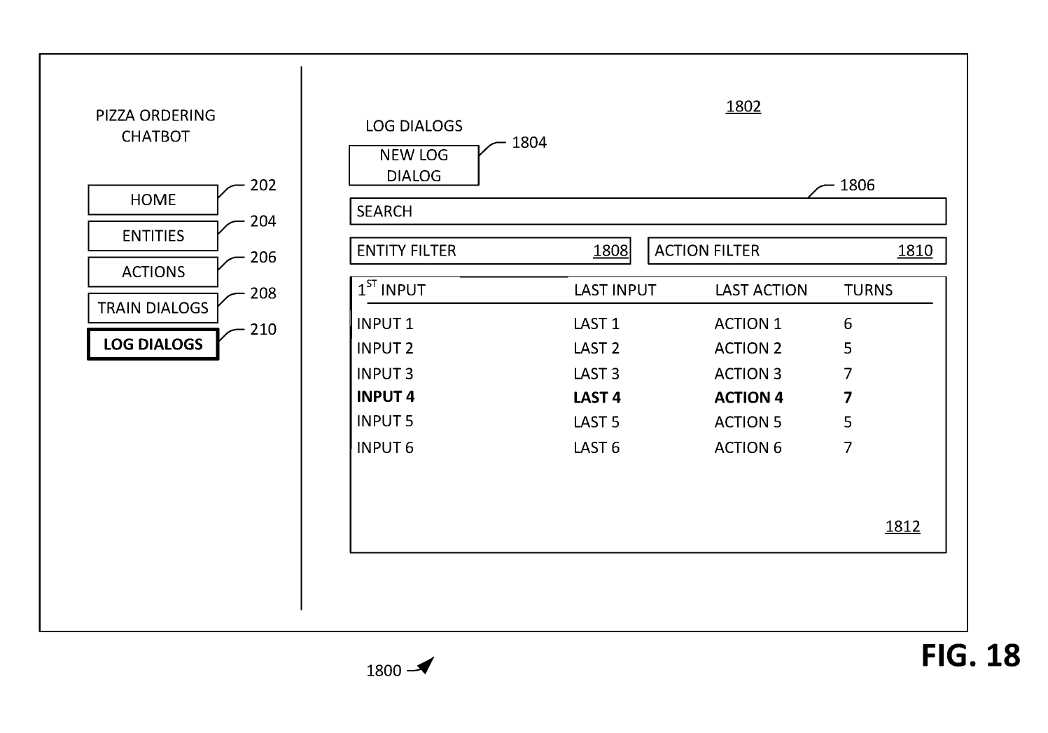

With reference now to FIG. 18, an exemplary GUI 1800 is illustrated, wherein the GUI presenter module 122 causes the GUI 1800 to be presented on the display 104 of the client computing device 102 responsive to the client computing device 102 receiving an indication that the developer has selected the log dialogs button 210. The GUI 1800 is analogous to the GUI 900 that depicts a list of selectable training dialogs. The GUI 1800 comprises a field 1802 that includes a new log dialog button 1804, wherein creation of a new log dialog between the developer and the chatbot is initiated responsive to the new log dialog button 1804 being selected. The field 1802 further includes a search field 1806, wherein a query for log dialogs can be included in the search field 1806, and further wherein (existing) log dialogs are searched over based upon such query. The search field 1806 is particularly useful when there are numerous log dialogs already in existence, thereby allowing the developer to relatively quickly identify a log dialog or log dialogs of interest. The field 1802 further comprises an entity filter field 1808 and an action filter field 1810, which allows for existing log dialogs to be filtered based upon entities referenced in the log dialogs and/or actions performed in the log dialogs. Such fields can be text entry fields, pull-down menus, or the like.

The GUI 1800 further comprises a field 1812 that includes several rows for existing log dialogs, wherein each row corresponds to a respective log dialog, and further wherein each row includes: an identity of a first input from an end user (who may or may not be the developer) to the chatbot; an identity of a last input from the end user to the chatbot, an identity of the last response of the chatbot to the end user, and a total number of dialog turns between the end user and the chatbot. It is to be understood that the information in the rows is set forth to assist the developer in differentiating between various log dialogs and finding desired log dialogs, and that any suitable type of information that can assist a developer in performing such tasks is contemplated.

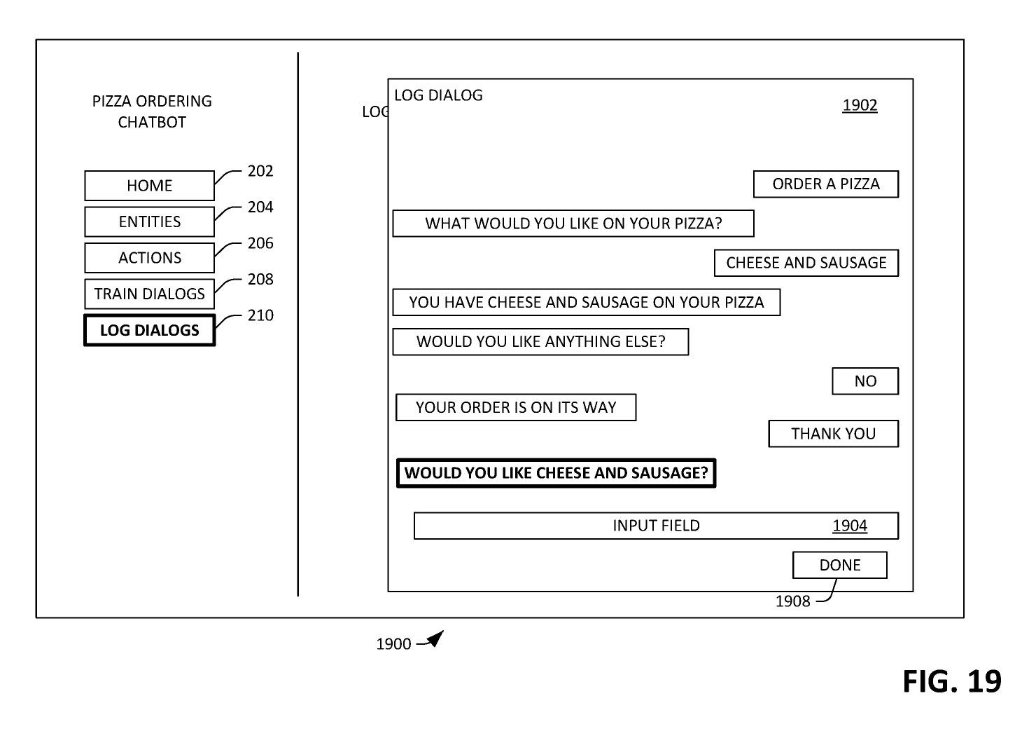

Now referring to FIG. 19, an exemplary GUI 1900 is illustrated, wherein the GUI presenter module 122 causes the exemplary GUI 1900 to be shown on the display 104 of the client computing device 102 responsive to the client computing device 102 receiving an indication from the developer that the developer has selected the new log dialog button 904, and has further interacted with the chatbot. The GUI 1900 is similar or identical to a GUI that may be presented to an end user who is interacting with the chatbot. The GUI 1900 includes a field 1902 that depicts the log dialog being created by the developer. The exemplary log dialog depicts dialog turns exchanged between the developer (with dialogs set forth by the developer biased to the right) and the chatbot (with dialog turns output by the chatbot biased to the left). In an example, the field 1902 includes an input field 1904, wherein the input field 1904 is configured to receive a new dialog turn from the developer for continuing the log dialog. The field 1902 further includes a done button 1908, wherein selection of the done button results in the log dialog being retained (but removed from the GUI 1900).

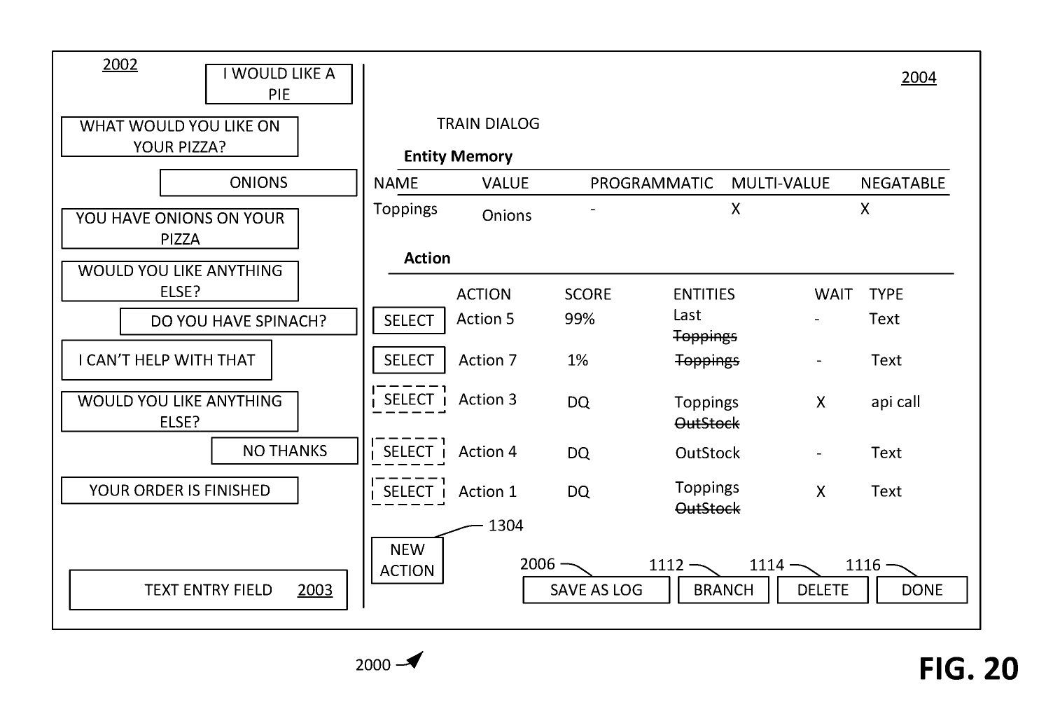

With reference now to FIG. 20, an exemplary GUI 2000 is illustrated, wherein the GUI presenter module 122 causes the GUI 2000 to be shown on the display 104 of the client computing device 102 in response to the developer selecting a log dialog from the list of selectable log dialogs (e.g., the fourth log dialog in the list of log dialogs). The GUI 2000 is configured to allow for conversion of the log dialog into a training dialog, which can be used by the updater module 124 to retrain the entity extractor module 116 and/or the response model 118. The GUI 2000 includes a field 2002 that is configured to display the selected log dialog. For instance, the developer may review the log dialog in the field 2002 and ascertain that the chatbot did not respond appropriately to a dialog turn from the end user. Additionally, the field 2004 can include a text entry field 2003, wherein the developer can set forth text input to continue the dialog.

In an example, the developer can select a dialog turn in the field 2002 where the chatbot set forth an incorrect response (e.g., “I can't help with that.”). Selection of such dialog turn causes a field 2004 in the GUI to be populated with actions that can be output by the response model 118, arranged by computed appropriateness. As described previously, the developer can specify the appropriate action that is to be performed by the chatbot, create a new action, etc., thereby converting the log dialog to a training dialog. Further, the field 2004 can include a “save as log” button 2006—the button 2006 can be active when the developer has not set forth any updated actions, and desires to convert the log dialog “as is” to a training dialog. The updater module 124 can then update the entity extractor module 116 and/or the response model 118 based upon the newly created training dialog. These features allow the developer to generate training dialogs in a relatively small amount of time, as log dialogs can be viewed and converted to training dialogs at any suitable point in the log dialog.

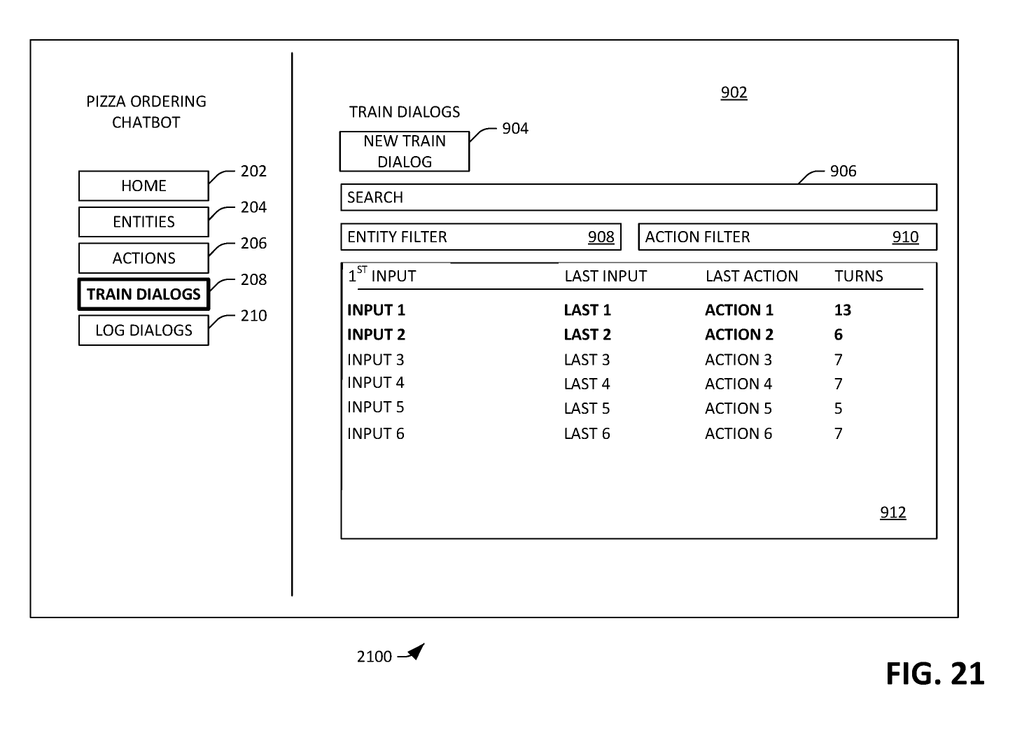

Moreover, in an example, the developer may choose to edit or delete an action, resulting in a situation where the chatbot is no longer capable of performing the action in certain situations where it formerly could, or is no longer capable of performing the action at all. In such an example, it can be ascertained that training dialogs may be affected; that is, a training dialog may include an action that is no longer supported by the chatbot (due to the developer deleting the action), and therefore the training dialog is obsolete. FIG. 21 illustrates an exemplary GUI 2100 that can be caused to be displayed on the display 104 of the client computing device 102 by the GUI presenter module 122, wherein the GUI 2100 is configured to highlight training dialogs that rely upon an obsolete action. In the exemplary GUI 2100, first and second training dialogs are highlighted, thereby indicating to the developer that the training dialogs refer to at least one action that is no longer supported by the response model 118 or is no longer supported by the response model 118 in the context of the training dialogs. Therefore, the developer can quickly identify which training dialogs must be deleted and/or updated.

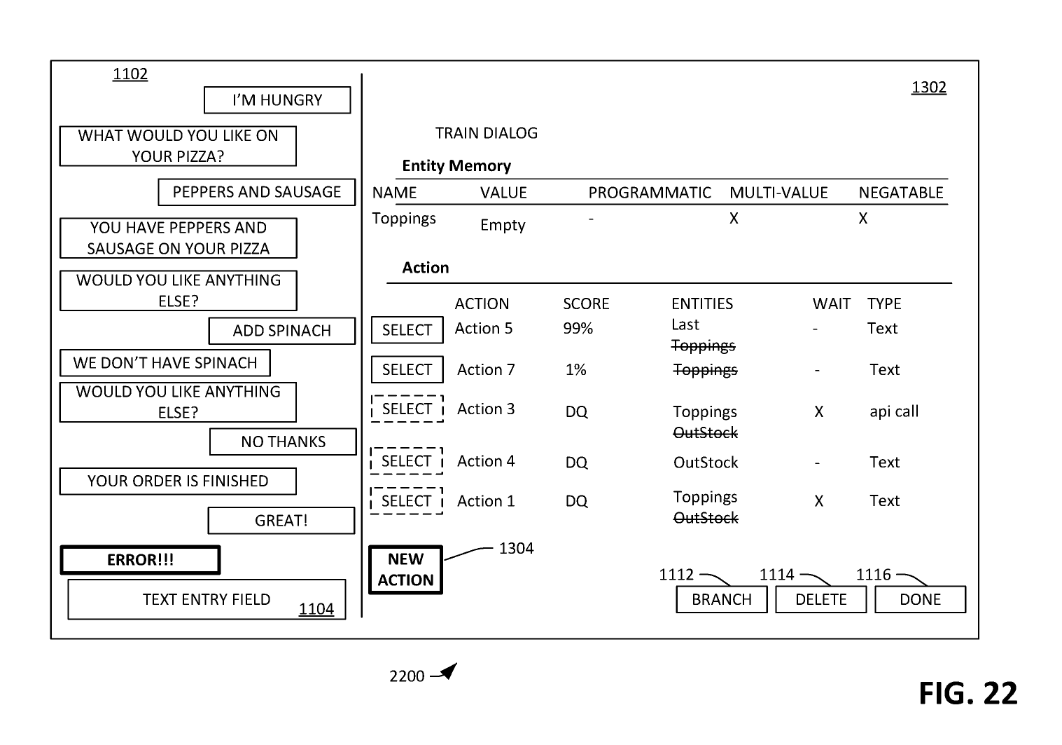

Now referring to FIG. 22, an exemplary GUI 2200 is illustrated, wherein the GUI presenter module 122 causes the GUI 2200 to be presented on the display 104 of the client computing device 102 responsive to the client computing device 102 receiving an indication that the developer selected one of the highlighted training dialogs in the GUI 2100. In the field 1302, an error message is shown, which indicates that the response model 118 no longer supports an action that was previously authorized by the developer. Responsive to the client computing device 102 receiving an indication that the developer has selected the error message (as indicated by bolding of the error message), the field 1302 is populated with available actions that are currently supported by the response model 118. Further, the actions that are not disqualified have a selectable “select” button corresponding thereto. Further, the field 1002 includes the new action button 1304. When such button 1304 is selected, the GUI presenter module 122 can cause the GUI 700 to be presented on the display 104 of the client computing device 102.

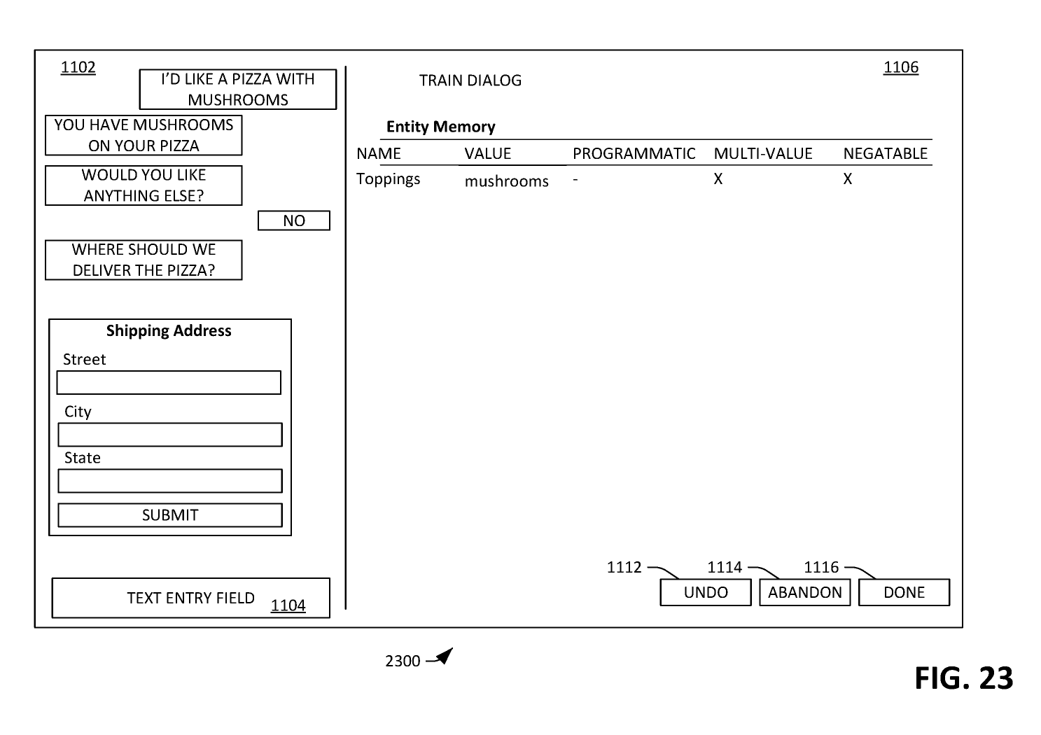

Referring briefly to FIG. 23, an exemplary GUI 2300 is illustrated, wherein the GUI presenter module 122 causes the GUI 2300 to be presented on the display 104 of the client computing device 102 responsive to the developer creating the action (as depicted in FIG. 8) and selecting the action as an appropriate response. A shipping address template 2302 is shown on the display, wherein the template 2302 comprises fields for entering an address (e.g., where pizza is to be delivered), and further wherein the template 2302 comprises a submit button. When the submit button is selected, content in the fields can be provided to a backend ordering system.

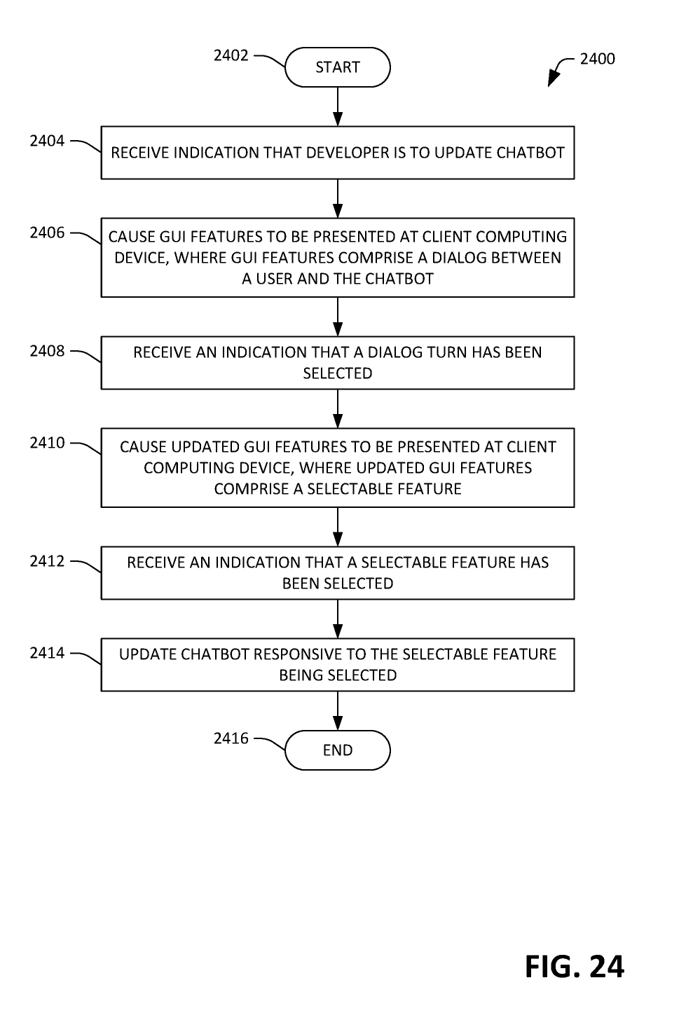

FIGS. 24-26 illustrate exemplary methodologies relating to creating and/or updating a chatbot. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

With reference now to FIG. 24, an exemplary methodology 2400 for updating a chatbot is illustrated, wherein the server computing device 106 can perform the methodology 2400. The methodology 2400 starts at 2402, and at 2404, an indication is received that a developer wishes to create and/or update a chatbot. For instance, the indication can be received from a client computing device being operated by the developer. At 2406, GUI features are caused to be displayed at the client computing device, wherein the GUI features comprise a dialog between the chatbot and a user. At 2408, a selection of a dialog turn is received from the client computing device, wherein the dialog turn is a portion of the dialog between the chatbot and the end user. At 2410, updated GUI features are caused to be displayed at the client computing device in response to receipt of the selection of the dialog turn, wherein the updated GUI features include selectable features. At 2412, an indication is received that a selectable feature in the selectable features has been selected, and at 2414 at least one of an entity extractor module or a response model is updated responsive to receipt of the indication. The methodology 2400 completes at 2416.

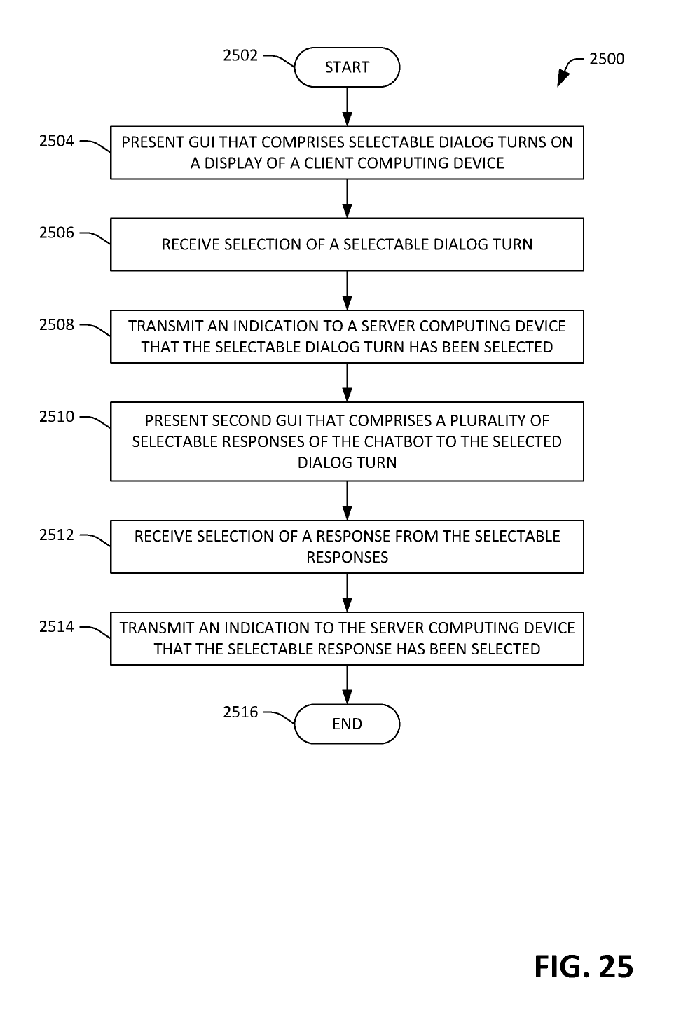

Now referring to FIG. 25, an exemplary methodology 2500 for updating a chatbot is illustrated, wherein the client computing device 102 can perform the methodology 2500. The methodology 2500 starts at 2502, and at 2504 a GUI is presented on the display 104 of the client computing device 102, wherein the GUI comprises a dialog, and further wherein the dialog comprises selectable dialog turns. At 2506, selection of a dialog turn in the selectable dialog turns is received, and at 2508 an indication is transmitted to the server computing device 106 that the dialog turn has been selected. At 2510, based upon feedback from the server computing device 106, a second GUI is presented on the display 104 of the client computing device, wherein the second GUI comprises a plurality of potential responses of the chatbot to the selected dialog turn. At 2512, selection of a response from the potential responses is received, and at 2514 an indication is transmitted to the server computing device 106 that the potential response has been selected. The server computing device updates the chatbot based upon the selected response. The methodology 2500 completes at 2516.

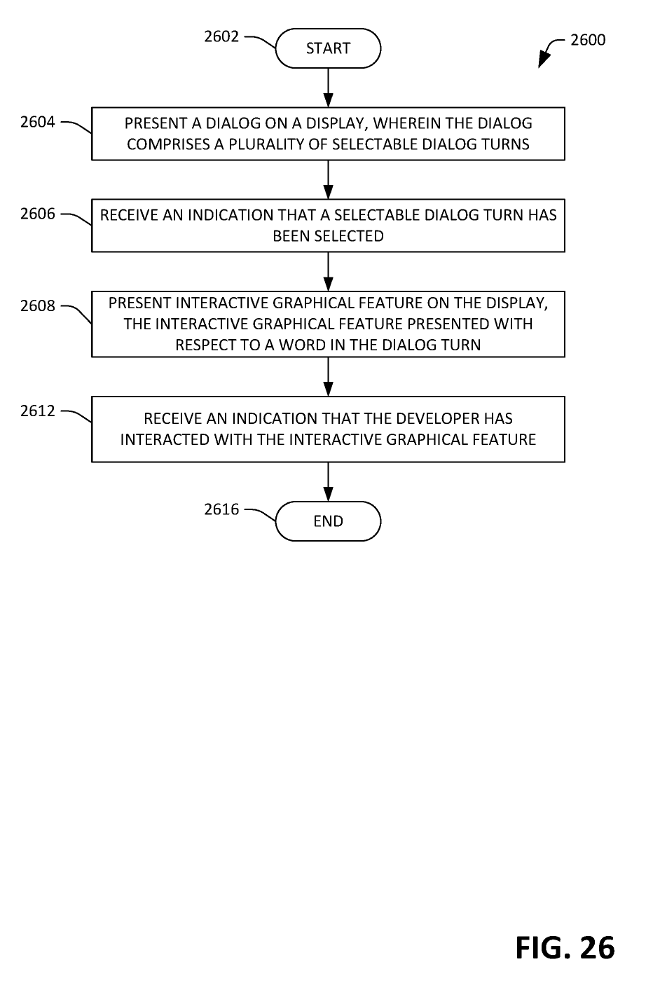

Referring now to FIG. 26, an exemplary methodology 2600 for updating an entity extraction label within a dialog turn is illustrated. The methodology 2600 starts at 2602, and at 2604, a dialog between an end user and a chatbot is presented on a display of a client computing device, wherein the dialog comprises a plurality of selectable dialog turns (some of which were set forth by the end user, some of which were set forth by the chatbot). At 2606, an indication is received that a selectable dialog turn set forth by the end user has been selected by the developer. At 2608, responsive to the indication being received, an interactive graphical feature is presented on the display of the client computing device, wherein the interactive graphical feature is presented with respect to at least one word in the selected dialog turn. The interactive graphical feature indicates that an entity extraction label has been assigned to the at least one word (or indicates that an entity extraction label has not been assigned to the at least one word). At 2610, an indication is received that the developer has interacted with the interactive graphical feature, wherein the entity extraction label assigned to the at least one word is updated based upon the developer interacting with the interactive graphical feature (or where an entity extraction label is assigned to the at least one word based upon the developer interacting with the interactive graphical feature). The methodology 2600 completes at 2612.

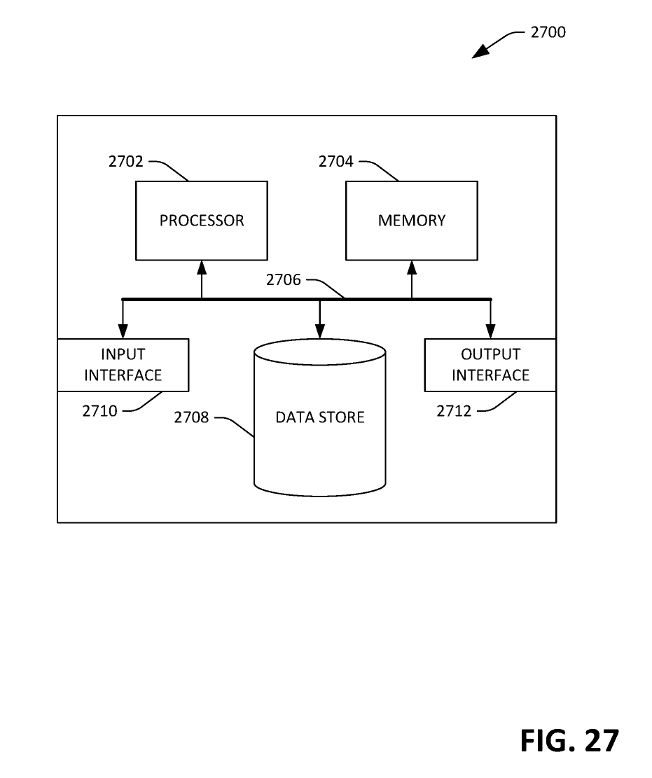

Referring now to FIG. 27, a high-level illustration of an exemplary computing device 2700 that can be used in accordance with the systems and methodologies disclosed herein is illustrated. For instance, the computing device 2700 may be used in a system that is configured to create and/or update a chatbot. By way of another example, the computing device 2700 can be used in a system that causes certain GUI features to be presented on a display. The computing device 2700 includes at least one processor 2702 that executes instructions that are stored in a memory 2704. The instructions may be, for instance, instructions for implementing functionality described as being carried out by one or more components discussed above or instructions for implementing one or more of the methods described above. The processor 2702 may access the memory 2704 by way of a system bus 2706. In addition to storing executable instructions, the memory 2704 may also store a response model, model weights, etc.

The computing device 2700 additionally includes a data store 2708 that is accessible by the processor 2702 by way of the system bus 2706. The data store 2708 may include executable instructions, model weights, etc. The computing device 2700 also includes an input interface 2710 that allows external devices to communicate with the computing device 2700. For instance, the input interface 2710 may be used to receive instructions from an external computer device, from a user, etc. The computing device 2700 also includes an output interface 2712 that interfaces the computing device 2700 with one or more external devices. For example, the computing device 2700 may display text, images, etc. by way of the output interface 2712.

It is contemplated that the external devices that communicate with the computing device 2700 via the input interface 2710 and the output interface 2712 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 2700 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 2700 may be a distributed system. Thus, for instance, several devices may be in communication by way of a network connection and may collectively perform tasks described as being performed by the computing device 2700.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for updating a chatbot, the method comprising:
receiving, from a client computing device, an indication that the chatbot is to be updated;
responsive to receiving the indication that the chatbot is to be updated, causing graphical user interface (GUI) features to be presented on a display of the client computing device, the GUI features comprise a selectable dialog turn, the selectable dialog turn belonging to a dialog that comprises dialog turns set forth by the chatbot;
receiving an indication that the selectable dialog turn has been selected by a user of the client computing device; and
based upon the indication that the selectable dialog turn has been selected by the user of the client computing device, updating the chatbot, wherein future dialog turns output by the chatbot in response to user inputs are a function of the updating of the chatbot.

2. The method of claim 1, wherein the chatbot comprises an entity extractor module that is configured to identify entities in input to the chatbot, and wherein updating the chatbot comprises updating the entity extractor module.

3. The method of claim 1, wherein the chatbot comprises an artificial neural network that is configured to select a response of the chatbot to user input, and further wherein updating the chatbot comprises updating the artificial neural network.

4. The method of claim 3, wherein updating the artificial neural network comprises updating weights assigned to synapses of the artificial neural network.

5. The method of claim 3, wherein updating the artificial neural network comprises assigning a new response to an output node of the artificial neural network.

6. The method of claim 3, wherein updating the artificial neural network comprises masking an output node of the artificial neural network.

7. The method of claim 1, wherein the dialog turn has been set forth by the chatbot, the method further comprising:
responsive to receiving the indication that the selectable dialog turn has been selected by the user of the client computing device, causing second GUI features to be presented on the display of the client computing device, the second GUI features comprise selectable potential outputs of the chatbot to the selected dialog turn; and
receiving an indication that an output in the selectable potential outputs has been selected by the user of the client computing device, wherein the chatbot is updated based upon the selected output.

8. The method of claim 1, wherein the dialog turn has been set forth by the user of the client computing device, the method further comprising:
responsive to receiving the indication that the selectable dialog turn has been selected by the user of the client computing device, causing second GUI features to be presented on the display of the client computing device, wherein the second GUI features comprise a proposed entity extracted from the dialog turn by the chatbot; and
receiving an indication that the proposed entity was improperly extracted from the dialog turn by the chatbot, wherein the chatbot is updated based upon the indication that the proposed entity was improperly extracted from the dialog turn by the chatbot.

9. The method of claim 1, wherein the dialog was previously conducted between the chatbot and an end user.

10. A server computing device comprising:
a processor; and
memory storing instructions that, when executed by the processor, cause the processor to perform acts comprising:
receiving an indication that a user has interacted with a selectable graphical user interface (GUI) feature presented on a display of a client computing device, wherein the client computing device is in network communication with the server computing device; and
responsive to receiving the indication, updating a chatbot based upon the selected GUI feature.

11. The server computing device of claim 10, wherein the chatbot comprises an artificial neural network, wherein the selectable GUI feature corresponds to a new response for the chatbot, and further wherein updating the chatbot comprises assigning the new response for the chatbot to an output node of the artificial neural network.

12. The server computing device of claim 11, wherein the artificial neural network is a recurrent neural network.

13. The server computing device of claim 10, wherein the chatbot comprises an artificial neural network, wherein the selectable GUI feature corresponds to deletion of a response for the chatbot, and further wherein updating the chatbot comprises removing the response from the artificial neural network.

14. The server computing device of claim 10, wherein the chatbot comprises an artificial neural network, wherein the selectable GUI feature corresponds to identification of a proper response to a user-submitted dialog turn, and further wherein updating the chatbot comprises updating weights of synapses of the artificial neural network based upon the identification of the proper response to the user-submitted dialog turn.

15. The server computing device of claim 10, wherein a computer-implemented assistant comprises the chatbot.

16. The server computing device of claim 10, wherein the chatbot comprises an entity extraction module, wherein the selectable GUI feature corresponds to an entity that was incorrectly identified by the entity extraction module, and wherein updating the chatbot comprises updating the entity extraction module.

17. A computer-readable storage medium comprising instructions that, when executed by a processor, cause the processor to perform acts comprising:
causing graphical user interface (GUI) features to be presented on a display of a client computing device, the GUI features comprise a dialog between a user and a chatbot, the dialog comprises selectable dialog turns;
receiving an indication that a dialog turn in the dialog turns has been selected at the client computing device, wherein the dialog turn was output by the chatbot;
responsive to receiving the indication that dialog turn has been selected, causing a plurality of possible outputs of the chatbot to be presented on the display of the client computing device;
receiving an indication that an output in the plurality of possible outputs has been selected; and
updating the chatbot based upon the output in the plurality of possible outputs being selected.

18. The computer-readable storage medium of claim 17, wherein the chatbot comprises an artificial neural network, and further wherein updating the chatbot comprises updating weights assigned to synapses of the artificial neural network.

19. The computer-readable storage medium of claim 17, wherein the dialog turn is a response to most recent input from the user.

20. The computer-readable storage medium of claim 17, wherein the dialog turn is not a most recent dialog turn output by the chatbot.
